(19) United States
(12) Patent Application Publication
(10) Pub. No.: US 2005/0091311 A1
(43) Pub. Date: Apr. 28, 2005

(54) Method and apparatus for distributing multimedia to remote clients

(76) Inventors: Christopher D. Lund, San Diego, CA (US); Keith O. Rice, Escondido, CA (US); John Stallings, Spring Valley, CA (US); Jimmy Yuan, San Diego, CA (US); Jeffrey M. Davey, Fallbrook, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/903,214

(22) Filed: Jul. 29, 2004

Related U.S. Application Data
(60) Provisional application No. 60/503,248, filed on Sep. 15, 2003.
(60) Provisional application No. 60/491,167, filed on Jul. 29, 2003.

(51) Int. Cl. H04N 7/18

(52) U.S. Cl. 709/203

(57) ABSTRACT

Video and audio signals are streamed to remote viewers that are connected to a communication network. A host server receives an originating video and audio signal that may arrive from a single source or from a plurality of independent sources. The host server provides any combination of the originating video and audio signals to viewers connected to a communication network. A viewer requests the host server provide a combination of video and audio signals from the host server. The host server transmits an instruction set to be executed by the viewer. The instruction set causes the viewer to transmit parameters to the host user, including parameters relating to the processing capabilities of the viewer. The host server then transmits multimedia data to the viewer according to the received parameters. A plurality of viewers may be simultaneously connected to the host server. Each of the plurality of viewers may configure the received video and audio signals independent of any other viewer and may generate alerts based on the video and audio content.

### RELATED APPLICATIONS

This application claims priority under 35 U.S.C. §119(e) to U.S. Provisional Patent Application No. 60/503,248, filed Sep. 15, 2003, and to U.S. Provisional Patent Application No. 60/491,167, filed Jul. 29, 2003, which are hereby incorporated by reference in their entireties. This application is related to U.S. patent application Ser. No. 09/652,113, filed Aug. 29, 2000, which is incorporated by reference herein in its entirety.

### FIELD OF THE INVENTION

The invention relates to devices and systems for communicating over a network. More particularly, the invention relates to a method and apparatus for streaming a multimedia signal to remote viewers connected to a communication network.

### DESCRIPTION OF THE RELATED ART

The constantly increasing processing power available in hardware devices such as personal computers, personal digital assistants, wireless phones and other consumer devices allows highly complex functions to be performed within the device. The hardware devices can perform complex calculations in order to implement functions such as spreadsheets, word processing, database management, data input and data output. Common forms of data output include video and audio output.

Personal computers, personal digital assistants and wireless phones commonly incorporate displays and speakers in order to provide video and audio output. A personal computer incorporates a monitor as the display terminal. The monitor, or display, on most personal computers can be configured independently of the processor to allow varying levels of resolution. The display for personal computers is typically capable of very high resolution, even on laptop-style computers.

In contrast, displays are permanently integrated into personal digital assistants and wireless phones. An electronic device having a dedicated display device formats data for display using dedicated hardware. The processing capabilities of the hardware as well as the display capabilities limit the amount of information displayed and the quality of the display to levels below that typically available from a personal computer, where the lower quality is defined as fewer pixels per inch, the inability to display colors or a smaller viewing area.

A personal computer may integrate one of a number of hardware interfaces in order to display video output on a monitor. A modular video card or a set of video interface Integrated Circuits (IC's) is used by the personal computer to generate the digital signals required to generate an image on the monitor. The digital signals used by a computer monitor differ from the analog composite video signal used in a television monitor. However, the personal computer may incorporate dedicated hardware, such as a video capture card, to translate analog composite video signals into the digital signals required to generate an image on the monitor. Thus, the personal computer may display, on the monitor, video images captured using a video camera, or video images output from a video source such as a video tape recorder, digital video disk player, laser disk player, or cable television converter.

The video capture card, or equivalent hardware, also allows the personal computer to save individual video frames provided from a video source. The individual video frames may be saved in any file format recognized as a standard for images. A common graphic image format is the Joint Photographic Experts Group (JPEG) format that is defined in International Organization for Standardization (ISO) standard ISO-10918 titled DIGITAL COMPRESSION AND CODING OF CONTINUOUS-TONE STILL IMAGES. The JPEG standard allows a user the opportunity to specify the quality of the stored image. The highest quality image results in the largest file, and typically, a trade off is made between image quality and file size. The personal computer can display a moving picture from a collection of JPEG encoded images by rapidly displaying the images sequentially, in much the same way that the individual frames of a movie are sequenced to simulate moving pictures.

The volumes of data and image files generated within any individual personal computer provide limited utility unless the files can be distributed. Files can be distributed among hardware devices in electronic form through mechanical means, such as by saving a file onto a portable medium and transferring the file from the portable medium (e.g., floppy disks) to another computer.

Another method of transferring files between computers is by using some type of communication link. A basic communication link is a hardwired connection between the two computers transferring information. However, information may also be transferred using a network of computers.

A computer may be connected to a local network where multiple computers are linked together using dedicated communication links. File transfer speed on a dedicated network is typically constrained by the speed of the communication hardware. The physical network is typically hardwired and capable of providing a large signal bandwidth.

More widespread remote networks may take advantage of existing infrastructure in order to provide the communication link between networked processors. One common configuration allows remote devices to connect to a network using telephone land lines. The communication link is a factor that constrains data transfer speed, especially where low bandwidth communication links such as telephone land lines are used as network connections.

One well known public network that allows a variety of simultaneous communication links is the Internet. As used herein, “Internet” refers to a network or combination of networks spanning any geographical area, such as a local area network, wide area network, regional network, national network, and/or global network. As used herein, “Internet” may refer to hardwire networks, wireless networks, or a combination of hardwire and wireless networks. Hardwire networks may include, for example, fiber optic lines, cable lines, ISDN lines, copper lines, etc. Wireless networks may include, for example, RF communications, cellular systems, personal communication services (PCS) systems, satellite communication systems, packet radio systems, and mobile broadband systems.

Individual computers may connect to the Internet using communication links having vastly differing information bandwidths. On fast connection to the network uses fiber connections that are couples directly to the network “backbone”. Connections to the network having a lower information bandwidth may use E1 or T1 telephone line connections to a fiber link. Of course, the cost of the communication link typically is proportional to the available information bandwidth.

Network connections are not limited to computers. Any hardware device capable of data communication may be connected to a network. Personal digital assistants, as well as wireless phones, typically incorporate the ability to connect to networks in order to exchange data. Hardware devices often incorporate the hardware or software required to allow the device to communicate over the Internet. Thus, the Internet operates as a network to allow data transfer between computers, network-enabled wireless phones, and personal digital assistants.

One potential use of networks is the transfer of graphic images and audio data from a host to a number of remote viewers. As discussed above, a computer can store a number of captured graphic images and audio data within its memory. These files can then be distributed over the network to any number of viewers. The host can provide a simulation of real-time video by capturing successive video frames from a source, digitizing the video signal, and providing access to the files. A viewer can then download and display the successive files. The viewer can effectively display real-time streaming video where the host continually captures, digitizes, and provides files based on a real-time video source.

The distribution of captured real-time video signals over a network presents several challenges. For example, there is limited flexibility in the distribution of files to various users. In one embodiment, a host captures the video and audio signals and generates files associated with each type of signal. As previously discussed, graphic images are commonly stored as JPEG encoded images. The use of JPEG encoding can compress the size of the graphic image file but, depending on the graphic resolution selected by the host, the image file may still be very large. The network connection at the host may act as an initial bottleneck to efficient file transfer. For example, if the host sends files to the network using only a phone modem connection to transfer multiple megabyte files, a viewer will not be able to immediately display the video and audio signals in a manner resembling real-time streaming video.

The viewer's network connection becomes another data transfer bottleneck, even if the host can send files to the network instantaneously. A viewer with a phone modem connection will typically not be able to transfer high-resolution images at a speed sufficient to support real-time streaming video.

One option is for the host to capture and encode any images in the lowest possible resolution to allow even the slowest connection to view real-time streaming video. However, the effect of capturing low-resolution images to enable the most primitive system's access to the images is to degrade the performance of a majority of viewers. Additionally, the images may need to be saved in such a low resolution that most detail is lost from the images. Degradation of the images, therefore, is not a popular solution.

Another difficulty encountered in streaming video between users with different bandwidth capabilities is the inability of all users to support the same graphical image format selected by the host. Most personal computers are able to support the JPEG image format; however, network-enabled wireless phones or personal digital assistants may not be able to interpret the JPEG image format. Additionally, the less sophisticated hardware devices may not incorporate color displays. Access to video images should be provided to these users as well.

Finally, in such video distribution systems, the viewer typically has little control over the images. The viewer relies primarily on the host to provide a formatted and sized image having the proper view, resolution, and image settings. The viewer cannot adjust the image being displayed, the image resolution, or the image settings such as brightness, contrast and color. Further, the viewer is unable to control such parameters as compression of the transmitted data and the frame rate of video transmission.

### SUMMARY OF THE INVENTION

The present invention is directed to an apparatus and method of transferring video and/or audio data to viewers such that the viewers can effectively display real-time streaming video output and continuous audio output. The apparatus and method may adapt the streaming video to each viewer such that system performance is not degraded by the presence of viewers having slow connections or by the presence of viewers having different hardware devices. The apparatus and method can further provide a level of image control to the viewer where each viewer can independently control the images received.

In one embodiment, a method of distributing multimedia data to remote clients comprises receiving a request for data from a client, transmitting an applet to the client, launching the applet on the client, receiving client-specific parameters from the applet on the client, and sending multimedia data to the client according to the client-specific parameters.

In another embodiment, a method of archiving video images comprises capturing a first video image, capturing a second video image, determining a difference between the first video image and the second video image, encoding the difference between the first video image and the second video image, and storing, as a frame in a video archive, an encoded difference between the first video image and the second video image.

In another embodiment, a method of distributing multimedia data to remote clients comprises receiving a request for a multiple image profile, retrieving configuration data for a plurality of video sources in response to the request for the multiple image profile, communicating a multiple image view, and communicating a video image from the plurality of video sources for each view in the multiple image view, based on the configuration data.

In another embodiment, a method of archiving images comprises capturing video images, generating correlation data corresponding to the video images, storing compressed video images, and storing the correlation data. 10026] In another embodiment, a method of monitoring motion in video data comprising a plurality of video frames comprises comparing a plurality of correlation values to a predetermined threshold, wherein each correlation value is associated with a block of a particular video frame, determining a number of correlation values associated with the particular video frame that exceed the predetermined threshold, and indicating motion if the determined number is greater than a second predetermined threshold.

In another embodiment, a method of archiving data in a multimedia capture system comprises configuring a first storage node for storing multimedia data, configuring a storage threshold associated with the first storage node, configuring a second storage node for storing multimedia data, configuring a storage threshold associated with the second storage node, transferring multimedia data from a capture device to the first storage node while a total first node data remains less than the storage threshold associated with the first storage node, and transferring multimedia data from a capture device to the second storage node after the total first node data is not less than the storage threshold associated with the first storage node and while a total second node data remains less than the storage threshold associated with the second storage node.

In another embodiment, a method of monitoring activity comprises comparing a sensor output at a first location to a predetermined threshold, initiating based upon the step of comparing, a multimedia event, and storing multimedia data at a second location related to the multimedia event.

In another embodiment, a method of prioritizing the adjustment of video recording device attributes received from more than one source comprises setting as a first priority any requests to change the video recording device attributes that are received from a user, setting as a second priority any requests to change the video recording device attributes that are stored as default attributes, setting as a third priority any requests to change the video recording device attributes that are automatically generated due to a triggering event at another video recording device, and adjusting the video recording device attributes according to the top priority request.

### BRIEF DESCRIPTION OF THE DRAWINGS

The features, objectives, and advantages of the invention will become apparent from the detailed description set forth below when taken in conjunction with the drawings, wherein like parts are identified with like reference numerals throughout, and wherein:

FIGS. 1A-1C are functional block diagrams of one embodiment of a multimedia distribution system.

FIG. 2A is an overview of the main program shown in FIG. 1C.

FIG. 2B is a process flow diagram of video archiving and distribution.

FIG. 2C is a process flow diagram of motion detection.

FIG. 2D is a process flow diagram of host administration.

FIG. 3A is a block diagram of a personal computer implementing the host process.

FIG. 3B is a block diagram of a storage configuration embodiment coupled to the personal computer shown in FIG. 3A.

FIG. 4A is a diagram illustrating the video capture module.

FIG. 4B is a flow chart illustrating the function of the switching system.

FIG. 5A is a block diagram of a multimedia distribution module wherein the host operates as a server.

FIG. 5B is a block diagram illustrating the broadcast of video data by a web server.

FIG. 6 is a block diagram of a video stream format.

FIG. 7 is a block diagram of various video block formats.

FIG. 8 is a flow chart illustrating motion detection at a block level.

FIG. 9A is a flow chart illustrating motion detection at a frame level.

FIG. 9B is a flow chart illustrating image and audio recording.

FIG. 9C is a representation of a format of a stored clip.

FIG. 10 is a flow chart illustrating a method of transmitting only those video image blocks that change.

FIG. 11 is a block diagram of an audio stream format.

FIG. 12 is a flow chart illustrating the encoding and generation of an audio frame.

FIG. 13 is a block diagram illustrating the broadcast of audio data by a web server.

FIG. 14 is a flow chart illustrating the dynamic updating of the domain name system.

FIG. 15 is a block diagram of a system for mirroring audio and video data.

FIG. 16 is a flow chart of a user configuration process for remote viewing layouts.

FIG. 17 is a representation of a format of correlation data that can be included with a stored clip.

FIG. 18A is a flowchart of a process for generating the correlation data that is stored in the clip file.

FIG. 18B is a flowchart of a process for determining quantized correlation values.

FIG. 19 is a flowchart of a process of searching a stored file for motion based in part on correlation values.

FIGS. 20A-20C are functional block diagrams of multiple camera control command flow.

FIG. 21 is a timeline of command flows in and out of a command queue.

### DETAILED DESCRIPTION OF THE PREFERRED EMBODIMENTS

As used herein, a computer, including one or more computers comprising a web server, may be any microprocessor or processor controlled device or system that permits access to a network, including terminal devices, such as personal computers, workstations, servers, clients, mini computers, main-frame computers, laptop computers, a network of individual computers, mobile computers, palm-top computers, hand-held computers, set top boxes for a television, interactive televisions, interactive kiosks, personal digital assistants, interactive wireless communications devices, mobile browsers, or a combination thereof. The computers may further possess input devices such as a keyboard, mouse, touchpad, joystick, pen-input-pad, and output devices such as a computer screen and a speaker.

These computers may be uni-processor or multi-processor machines. Additionally, these computers include an addressable storage medium or computer accessible medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, video tapes, audio tapes, magnetic recording tracks, electronic networks, and other techniques to transmit or store electronic content such as, by way of example, programs and data. In one embodiment, the computers are equipped with a network communication device such as a network interface card, a modem, or other network connection device suitable for connecting to a networked communication medium.

Furthermore, the computers execute an appropriate operating system such as Linux, Unix, Microsoft® Windows®, Apple® MacOS®, and IBM® OS/2®. As is convention, the appropriate operating system includes a communications protocol implementation, which handles all incoming and outgoing message traffic passed over a network. In other embodiments, while different computers may employ different operating systems, the operating system will continue to provide the appropriate communications protocols necessary to establish communication links with a network.

The computers may advantageously contain program logic, or other substrate configuration representing data and instructions, which cause the computer to operate in a specific and predefined manner as described herein. In one embodiment, the program logic may advantageously be implemented as one or more modules or processes.

As can be appreciated by one of ordinary skill in the art, each of the modules or processes may comprise various sub-routines, procedures, definitional statements and macros. Each of the modules is typically separately compiled and linked into a single executable program. Therefore, the description of each of the modules in this disclosure is used for convenience to describe the functionality of the preferred system. Thus, the processes that are performed by each of the modules may be arbitrarily redistributed to one of the other modules, combined together in a single module, or made available in, for example, a shareable dynamic link library.

The modules may advantageously be configured to reside on the addressable storage medium and configured to execute on one or more processors. The modules include, but are not limited to, software or hardware components that perform certain tasks. Thus, a module may include, by way of example, components, such as, software components, object-oriented software components, class components and task components, processes, functions, attributes, procedures, subroutines, segments of program code, drivers, firmware, microcode, Java byte codes, circuitry, data, databases, data structures, tables, arrays, and variables.

As used herein, multimedia refers to data in any form. For example, it may include video frames, audio blocks, text data, or any other data or information. Multimedia information may include any individual form or any combination of the various forms.

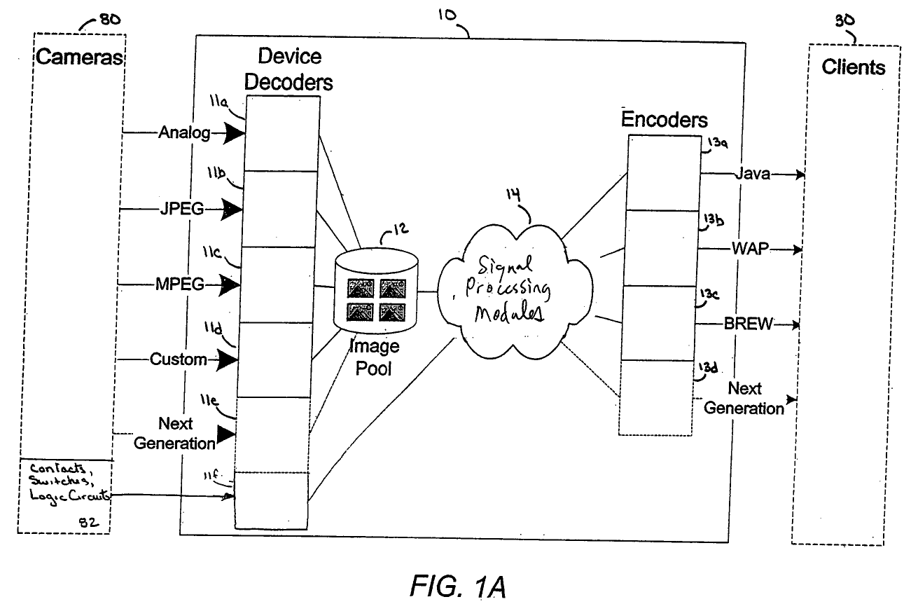

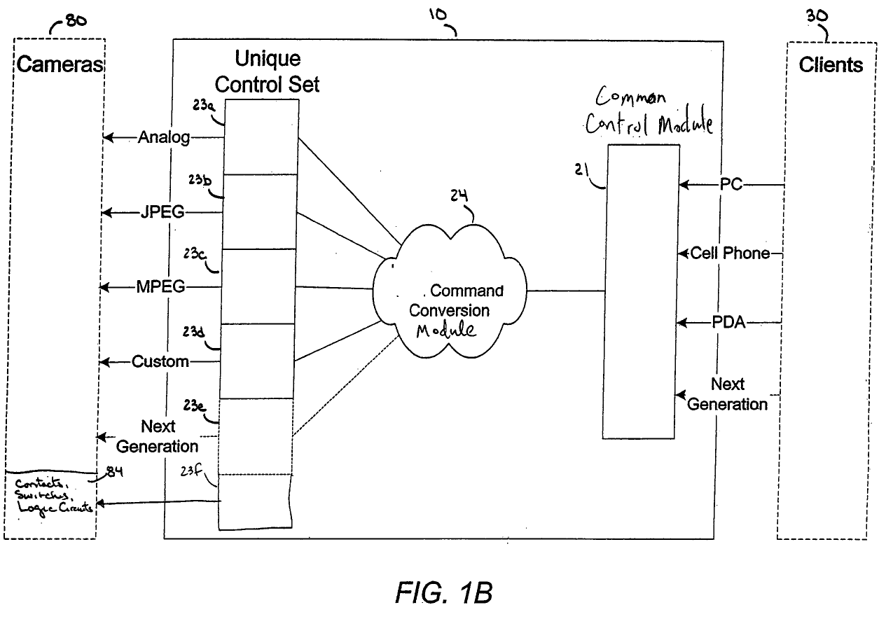

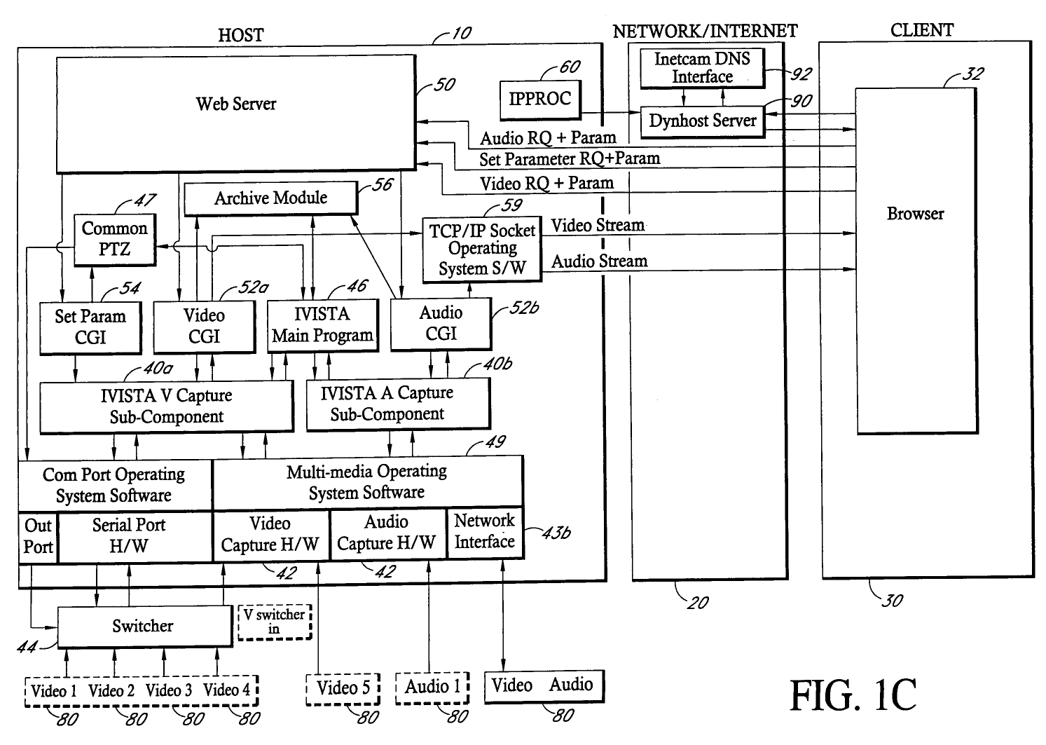

A functional block diagram of a multimedia capture and distribution system is shown in FIG. 1A. The multimedia capture and distribution system may be separated into three main functional blocks, external device 80, host 10, and clients 30. The external device 80 connect to the host 10, which receives and processes the captured multimedia. The host 10 then stores and/or distributes the processed multimedia to clients 30.

The external device 80 can also be a single external device 80 or can be multiple external devices 80. The term external refers to the typical placement of the device external to the host 10. However, the external device 80 can be internal to the host, such as a personal computer with a built in camera and microphone. The external device 80 may be, in one embodiment, video and audio capture devices.

In one embodiment, the external devices 80 are video capture devices. The video capture devices may have the same or different output formats. For example, the external device 80 in FIG. 1A represents five different cameras, with each of the cameras providing a different output format. A first camera can be, for example, an analog camera that provides an output in an analog format, such as NTSC, PAL, or SECAM. A second camera can provide an output according to a JPEG standard. A third camera can provide an output according to a MPEG standard. A fourth camera can provide an output according to a custom specification. Still other cameras can provide outputs according to other next generation standards or specifications. Of course, the external devices 80 need not be cameras or even video capture devices, but can be any means for providing an input signal to the host 10.

In one embodiment, the external devices 80 can include input contacts, switches, or logic circuits 82 and the like, or some other devices for generating an input signal. One or more device decoders, for example 11f, implemented in the host 10 can be configured to process the contact, switch, or logic circuit 82 values into the common format used by either the image pool 12 or other signal processing modules 14. For example, using the appropriate device decoder 11f, the host 10 can sense the state of a contact or switch that is part of logic circuits 82. Contacts or switches can be, for example, normally open or normally closed contacts. The associated device decoder 11f can process the contact state to a logic value that can be stored in the common image pool 12 or processed by the signal processing modules 14. In one example, the device decoder 11f can sense the position of an input contact that is part of logic circuits 82, that may be an alarm sensor. The state of the input contact can trigger responses within the host 10. For example, an archiving process can be configured to record a predetermined duration of images captured from a designated camera in response to a trigger of an alarm sensor. The archiving process may continue until the alarm contact returns to its normal state or until a predetermined timeout. A predetermined contact reset timeout can be, for example 30 seconds.

One or more switches can be binary switches or can be multiple position switches. The associated device decoder 11f can convert the switch state to a logic value or binary stream that can be further processed in the host 10. For example, a device decoder 11f can produce a four bit binary value indicative of each of the states of a switch having sixteen positions.

Similarly, the external devices 80 can include one or more logic circuits 82 that can provide input data to an associated device decoder 11f. The device decoder 11f can, for example, convert data from input logic circuits into data that is compatible with the host 10. For example, a device decoder 1 if can receive data from external CMOS, TTL, or ECL logic circuits and generate data in a common signal format, such as TTL data, to be further processed by the host 10.

In the embodiment of FIG. 1A, the host 10 receives the signals provided by the external device 80 and processes the signal to produce signals having a common format. As in the above-described embodiment, where the external devices are cameras or video devices, the host 10 receives each of the different video formats and, using a corresponding device decoder 11a-11e, decodes the received signal to a common format. For example, each of the received video signal formats, whether analog, JPEG, MPEG, or custom, are decoded to a common signal format used within the host 10. The video streams are then stored in a common image pool 12 to be further processed and distributed to clients 30. Audio input can similarly be decoded and stored in a common audio pool.

The common image pool 12 can be, for example, a database or memory where files or tables of images are stored. Images from the common image pool can be coupled to various signal processing modules 14. The signal processing modules 14 can include, for example, image processing modules such as compression, streaming, motion detection, and archiving modules.

The signal processing modules 14 are coupled to signal encoders corresponding to a signal format used by a client 30. Thus, one or more images in the image pool 12 can be, for example, compressed and streamed to a first encoder 13a that encodes the processed signal into a format for a JAVA applet. Similarly, other signal encoders 13b-13d can be configured to encode the processed signals into other signal formats. The encoders can, for example, encode the processed signals to WAP, BREW, or some other signal format used by clients 30.

The host 10 architecture allows for expansion to support additional or new input and output formats. Because the signal processing modules 14 operate on signals from the common signal pool 12, new input and output devices may be supported with the addition of new decoders 11 and encoders 13. In order to support an additional or new input format from another external device 80, only an additional device decoder 11 needs to be added to the host 10. Similarly, to support a new client signal format, only a new encoder 13 needs to be developed.

FIG. 1B is a functional block diagram of the multimedia capture and distribution system showing how the host 10 architecture can similarly be used to support one or more client 30 controls of external devices 80. In this embodiment, clients 30 provide command instructions to the host 10 using a common control set.

In the embodiment of FIG. 1B, the host 10 receives control commands from clients 30 or internal modules and identifies them as control commands using a common control module 21. The control commands from the common control module 21are coupled to a command conversion module 24. The command conversion module 24 converts the commands from the common control module 24 to a unique control set corresponding to a particular external device 80. The commands in the unique control set are then coupled to one or more of the control modules 23a-23e corresponding to external devices 80.

In one embodiment, the clients 30 are display devices and the external devices 80 are video cameras having pan, tilt, and zoom (PTZ) capabilities. Each of the external devices 80 may have a unique PTZ control set associated with the camera. However, because the host 10 architecture provides for a common control set, each of the clients 30 may use a single PTZ control set to control any camera under their control.

Additionally, the external devices 80 can include cameras having pan, tilt, and zoom capabilities. The external devices 80 can include cameras having zoom capabilities that are mounted on platforms that can be controlled to provide pan and tilt capabilities. Thus, a stationary camera positioned on a controllable platform or mount can appear to the host 10 as a camera having pan and tilt capabilities. Additionally, a camera may be coupled to a motorized lens that enables zoom capabilities in the camera. A subset of cameras may incorporate PTZ capabilities while other cameras provide PTZ capabilities through the use of assisting devices, such as motorized lenses or motorized platforms.

The PTZ controls to the external devices 80 may be multiplexed on the same channels that the external devices use to communicate captured data to the host 10. In other embodiments, the PTZ controls to the external devices 80 may be communicated along dedicated channels or ports. The host 10 may use a custom or standard communication protocol to control the camera PTZ. For example, the PTZ control set may be communicated to the camera using communication protocols such as RS-232, RS-485, IEEE-488, IEEE-802, and the like, or some other means for communication. The communication protocol used by the camera or external device 80 can be configured when the camera or external device 80 is configured to operate with the host 80. For example, a user can select a communication port and logical device, such as a camera, when the camera is initially configured with the host 80. The command conversion module 24 in the host 10 converts the common control set to the control sets used by the external devices 80. For example, a first client can be a personal computer and can control, via the host 10, a JPEG camera. The first client sends PTZ controls using a common control set to the host 10. The command conversion module 24 converts the common control command to the unique PTZ command used by the JPEG camera. A control module 23b then transmits the control command to the JPEG camera. Similarly, if the first client controls the analog camera, the command conversion module 24 converts a PTZ command from the common control set to a PTZ command used by the analog camera. A control module 23a transmits the PTZ command to the analog camera.

In still another embodiment, the external devices 80 include output contacts, switches, or logic circuits 84. The output contacts, switches, or logic circuits 84 may include the input contacts, switches, or logic circuits 82 shown in FIG. 1A or may be independent of the external input devices. The output contacts, switches, and logic circuits 84 may be controlled manually or in response to a trigger configured within the host 10. For example, a motion detection module within the host 10 may automatically control the position of output contacts or switches to predetermined states in response to sensing motion in video images captured by a camera.

Thus, the common control set and command conversion module 24 implemented in the host 10 allows any client or host module to control various external devices 80 without any knowledge of the unique control set used by the external device 80. External devices 80 can be controlled in response to any number of events. For example, clients 30 may control external devices 80 using a common control set. Additionally, modules within the host 10 can control external devices 80 in response to predetermined events. For example, a motion detection module can control external devices 80 such as cameras, contact closures, and switch positions in response to motion events or input trigger profiles.

A more detailed functional block diagram of a multimedia distribution system according to aspects of the invention is shown in FIG. 1C. The system is composed of a host 10 interface that is coupled to at least one client 30 via a network 20. The host 10 is a computer including one or more processes or modules and may interface with various hardware devices on the computer. A process or module may be a set of instructions implemented in software, firmware or hardware, including any type of programmed step undertaken by components of the system. The client 30 is another computer including one or more process or modules. Advantageously, the client 30 is a remote computer interconnected to the host 10 through a network 20. The network 20 is any type of communication network as is commonly known by one skilled in the field and as was described previously. The network 20 may be a Local Area Network (LAN), a Wide Area Network (WAN), a public network such as the Internet, or a wireless network or any combination of such networks. The network 20 interconnection between the host 10 and the client 30 may be accomplished using hard wired lines or through wireless Radio Frequency (RF) links, for example. The various embodiments of the invention are not limited by the interconnection method used in the network 20 or the physical location of the host 10 or clients 30.

A number of processes operate within the host 10 in order to allow the host 10 to interface with external devices 80 and with the client 30 through the network 20. One or more capture devices 42 interface with external devices 80 in order to transform the data provided by an external devices 80 into a format usable by the host 10. The host 10 can include one or more capture devices 42 and each capture device 42 can interface with one or more external devices 80. Additionally, the host 10 can include hardware that supports one or more data ports, such as a serial port 43a or a network interface 43b. The network interface 43b can be, for example, a network interface card coupled to a LAN or WAN, such as the Internet. The host 10 can also be coupled to one or more external devices 80 through the data ports.

In one embodiment, the capture device 42 is a video capture card that interfaces to an external video source. The video source may be generated by a video camera, video disc player, video cassette recorder, television video output, or any other device capable of generating a video source. The video capture card grabs the frames from the video source, converts them to digital signals, and formats the digital signals into a format usable by the host 10. The external device 80 may also be a video card within a computer for converting video signals that are routed to a monitor into a format usable by the host 10. The host 10 can then operate on the video card images in the same manner as images captured by an external video camera. For example, the screen images can be recorded or processed for the presence of motion. Additionally, the screen images may be enlarged using digital zoom capabilities.

The external devices 80 are not limited to video sources and can include devices or sources providing data in other formats. For example, the external devices 80 may generate audio data. The capture device 42 interfaces with an audio source to convert the input signal to a digital signal, then to convert the digital signals into a format usable by the host 10. A variety of external devices 80 may be used to provide an audio signal. An audio signal may be provided from a microphone, a radio, a compact disc player, television audio output, or any other audio source.

Multiple external devices 80 may interface with the host 10. The external devices 80 may provide inputs to the host 10 simultaneously, sequentially, or in some combination. A switcher module 44 including a controllable switch (not shown) may be used to multiplex signals from multiple sources to a single capture device 42. The switcher 44 is used where multiple sources are controlled and may be omitted if the host 10 does not have control over the selection of the source. If used, the switcher 44 receives control information through a communication port on the computer. An exemplary embodiment of a hardware switch used to multiplex multiple video sources to a single video capture card is provided in copending U.S. patent application Ser. No. 09/439,853, filed Nov. 12, 1999, entitled SIGNAL SWITCHING DEVICE AND METHOD, assigned to the assignee of the current application, and hereby incorporated herein by reference. A similar hardware switch may be used to multiplex multiple audio sources to a single audio capture card.

The host 10 can also transmit commands to the external devices 80 using the data ports. In one embodiment, the external devices 80 are video cameras and the host 10 can send PTZ commands to the cameras to adjust the captured images. The host 10 can send PTZ commands to cameras that are connected to a bidirectional serial port 43a, for example. Additionally, the host 10 can send PTZ commands to cameras in the network that are coupled to the network interface 43b. If the cameras connected to the network are individually addressable, the host 10 can send commands to each networked camera independent of commands sent to any other camera.

A multimedia operating system module 49 allows the capture devices to interface with one or more capture modules 40a, 40b. The capture modules 40a, 40b monitor the capture devices and respond to requests for images by transmitting the captured information in JPEG-encoded format, for example, to the main program module 46.

The host also includes a web server module 50, such as the Apache web server available from the Apache Software Foundation. The web server 50 is used to configure the host 10 as a web server. The web server 50 interfaces the host 10 with the various clients 30 through the network 20. The web server 50 sets up an initial connection to the client 30 following a client request. One or more Common Gateway Interfaces (CGI) 52a, 52b are launched for each client 30 by the web server module 50. Each CGI 52 submits periodic requests to the main program 46 for updated video frames or audio blocks. The web server 50 also configures the dedicated CGI 52 in accordance with the capabilities of each client 30. The client 30 may monitor the connection, and maintain some control, over the information sent through the CGI 52. The client 30 can cause the web server 50 to launch a “set param” CGI module 54 to change connection parameters. The web server 50 conveys the control information to the other host processes through the “set param” CGI 54. Once the web server 50 establishes the network connection, the CGI 52 controls the information flow to the client 30.

A common PTZ module 47 can be coupled to the “set param” CGI 54 and the main program 46. The common PTZ module 47 translates the common PTZ commands received by the host 10 into the unique PTZ commands corresponding to external cameras. The output of the common PTZ module 47 can be coupled to communications port modules to enable the PTZ commands to be communicated to the external devices 80 via the data ports 43a-b. In another embodiment, the common PTZ module 47 uses a CGI that is separate and distinct from the “set param” CGI 54.

An archive module 56 can operate under the control of the main program 46. The archive module 56 is coupled to the capture modules 40a-b to archive data that is captured by the modules. In one embodiment, the capture modules 40a-b are video and audio capture modules and the archive module 56 stores a predetermined segment of captured audio and video based in part on control provided by the main program 46.

The client 30 interfaces to the host through the network 20 using an interface module such as a browser 32. Commercially available browsers include Netscape Navigator and Microsoft's Internet Explorer. The browser 32 implements the communication formatting and protocol necessary for communication over the network 20. The client 30 is typically capable of two-way communications with the host 10. The two-way link allows the client 30 to send information as well as receive information. A TCP/IP socket operating system module 59 running on the host 10 allows the host to establish sockets for communication between the host 10 and the client 30.

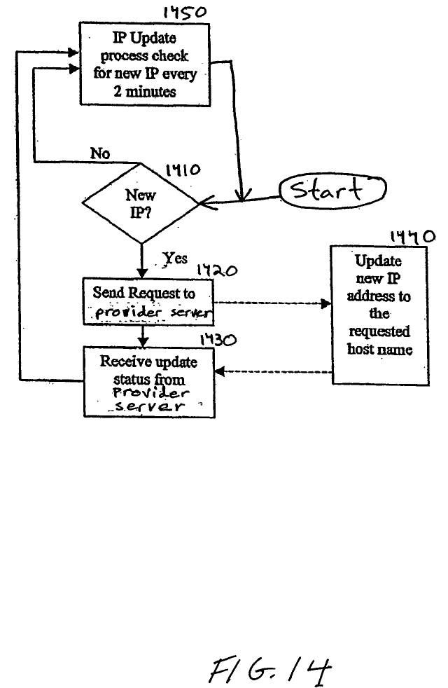

The host 10 may also incorporate other modules not directly allocated to establishing communications to the client 30. For example, an IP PROC 60 may be included within the host 10 when the host 10 is configured to operate over, for example, the Internet. The IP PROC 60 is used to communicate the host's 10 Internet Protocol (IP) address. The IP PROC 60 is particularly useful when the host's IP address is dynamic and changes each time the host 10 initially connects to the network 20. In one embodiment, the IP PROC 60 at the host 10 works in conjunction with a Domain Name System (DNS) host server 90 (described in further detail below with reference to FIG. 14) connected to the network to allow clients 30 to locate and establish a connection to the host 10 even though the host 10 has a dynamic IP address.

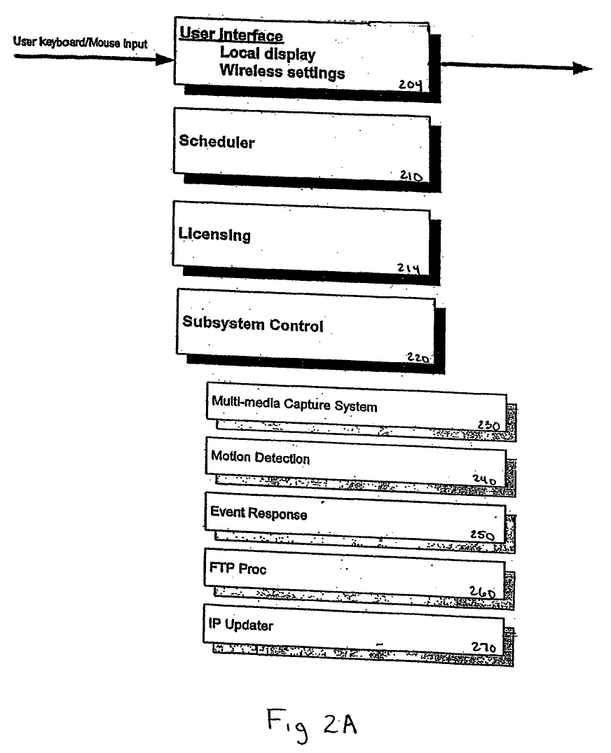

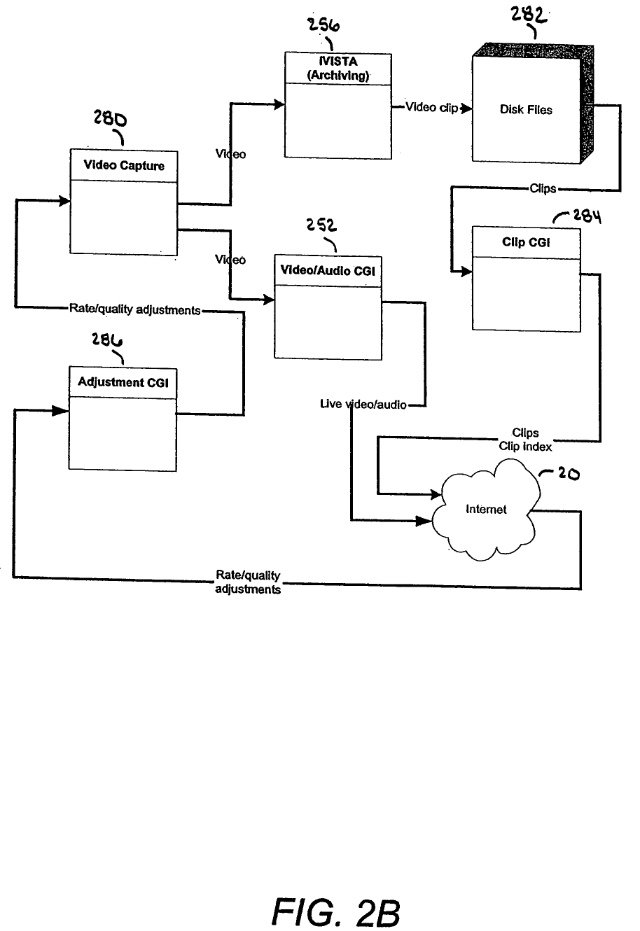

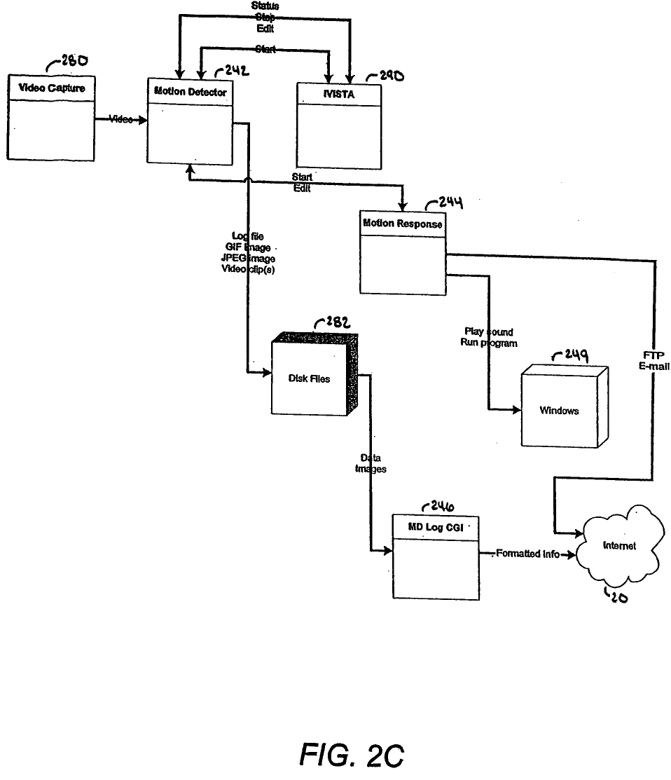

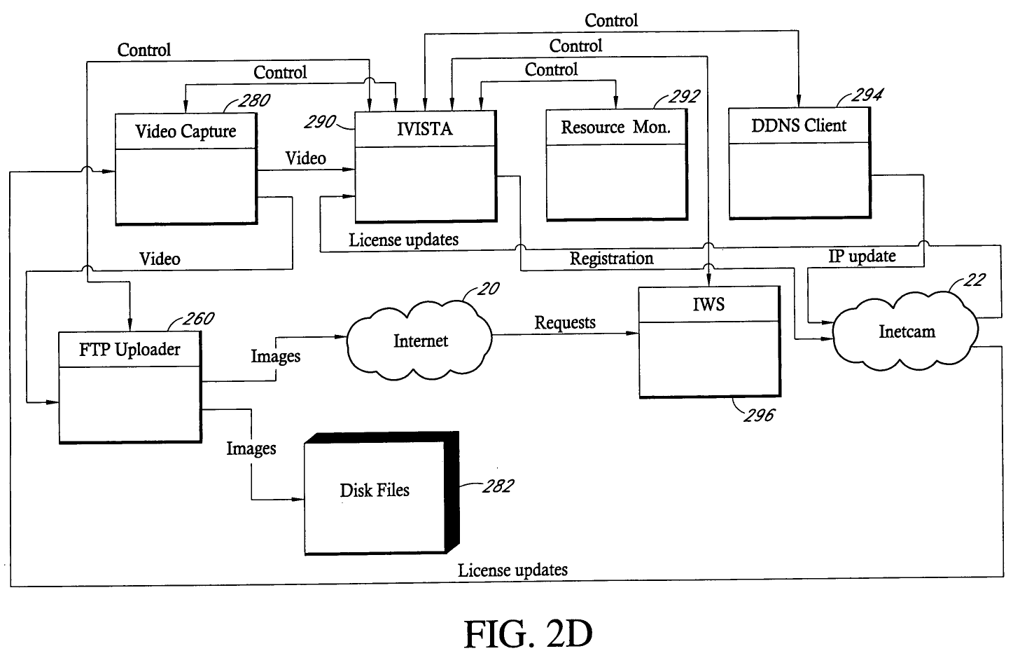

An overview of certain software modules that may be implemented in the host 10, such as in the main program module 46, is provided in FIG. 2A. The host implements a user interface 204 to receive input from the user through, for example, a keyboard or a mouse and to provide display and audio output to the user. The user interface 204 can be configured to allow users to assign external devices into logical groups to facilitate tracking of the external devices. As devices are added into logical groups, any motion profiles and schedules associated with the external device remain associated with the external device. Similarly, external devices can be removed from logical groups.

The output provided to a user may be in the form of an operating window displayed on a monitor that provides the user with an image display and corresponding control menus that can be accessed using a keyboard, a mouse or other user interface devices. A scheduler 210 operates simultaneously with the user interface 204 to control the operation of various modules. The user or an administrator of the host system may set up the scheduling of multimedia capture using the scheduler 210. Images or audio may be captured over particular time windows under the control of the scheduler 210 and those time windows can be selected or set by a user.

A licensing module 214 is used to either provide or deny the user access to specific features within the system. As is described in detail below, many features may be included in the system. The modularized design of the features allows independent control over user access to each feature. Independent control over user access allows the system to be tailored to the specific user's needs. A user can initially set up the minimum configuration required to support the basic system requirements and then later upgrade to additional features to provide system enhancements. Software licensing control allows the user access to additional features without requiring the user to install a new software version with the addition of each enhancement.

The host also performs subsystem control processes 220. The host oversees all of the subsystem processes that are integrated into the multimedia distribution system. These sub-processes or modules include the multimedia capture system 230 that controls the capture of the video and audio images and the processing and formatting of the captured data. There may be numerous independent CGI processes running simultaneously depending on the number of clients connected to the host and the host's capacity. Each of the CGI processes accesses the network and provides output to the clients depending on the available captured data and the capabilities of the client.

A motion detection 240 process operates on the captured images to allow detection of motion over a sequence of the captured images. Motion detection can be performed on the entire image or may be limited to only a portion of the image. The operation of motion detection will be discussed in detail later.

Another process is an event response 250. The event response 250 process allows a number of predefined events to be configured as triggering events. In addition to motion detection, the triggering event may be the passage of time, detection of audio, a particular instant in time, user input, or any other event that the host process can detect. The triggering events cause a response to be generated. The particular response is configurable and may include generation and transmission of an email message, generation of an audio alert, capture and storage of a series of images or audio, execution of a particular routine, or any other configurable response or combination of responses.

Additional processes include an FTP process 260 and an IP Updater process 270. As discussed with reference to FIG. 1C, the FTP process transfers the multimedia data to an FTP server to allow widespread access to the data. The IP Updater 270 operates to update the IP address of the host. The host may be identified by a domain name that is easily remembered. The domain name corresponds to an Internet Protocol address, but the host process may be connected to a network that utilizes dynamic IP addresses. The IP address of the server may change each time the host disconnects and reconnects to the network if dynamic IP addresses are used. The IP Updater 270 operates in conjunction with a Domain Name System (DNS) server to continually update the IP address of the host such that the host's domain name will always correspond to the appropriate IP address.

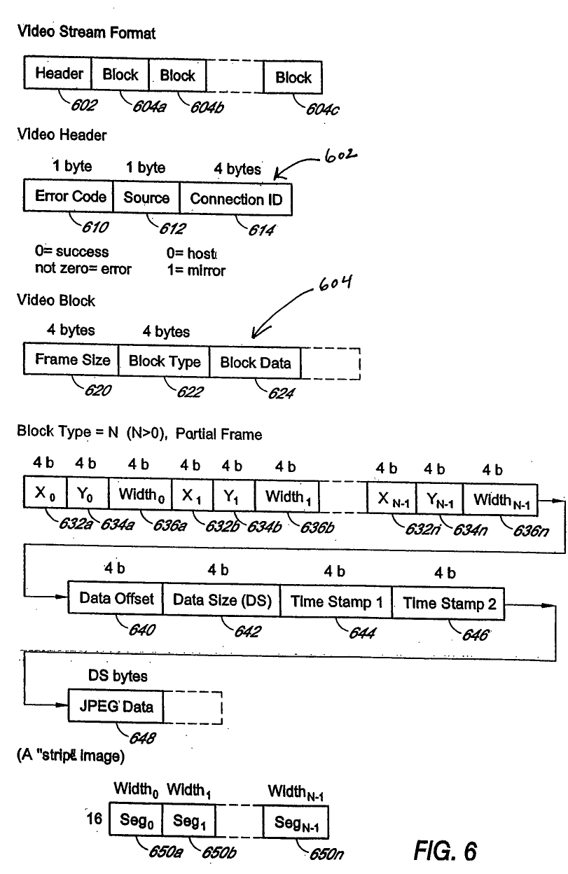

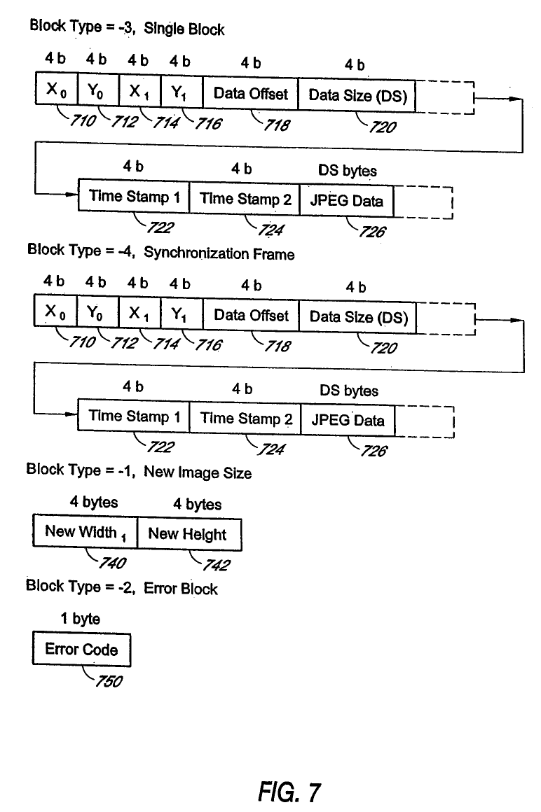

FIG. 2B is a process flow diagram of video archiving and distribution. The video archiving and distribution processes can be performed by various functional blocks of FIG. 1C. A video capture process 280 captures video from external devices. The video capture process 280 transforms the captured video from the external device into a common video signal format used within the host. Thus, the video capture process 280 can be configured to perform a different signal transformation depending on the input video format. A similar audio capture process, not shown, can be used to capture audio from external devices. In some embodiments, the video capture process 280 and audio capture process are performed in a single process. The capture process 280 can compress the captured video and audio to conserve storage space of archived files and to minimize signal bandwidth when the archived file is distributed. One embodiment of a video compression format is discussed in more detail below in association with FIGS. 6-7. In other embodiments, the video capture process 280 does not perform the video compression and subsequent modules perform the compression.

The captured video and audio, in the common host format, is then coupled to an archive process 256 and a video/audio CGI process 252. In one embodiment, the archive module 56 of FIG. 1C performs the archive process 256 and the video and audio CGIs 52a-b perform the video/audio CGI process 252. In the embodiment in which the video capture process 280 does not perform compression, the compression can be performed by the archive process 256 and the video/audio CGI 252.

The archive process 256 produces an archive file of the captured video and audio and can compress the captured images and audio. In one embodiment, the amount of captured video and audio that is archived is a predetermined amount controlled by the main program. The predetermined amount can be varied according to user input or may be a constant. In another embodiment, the archive process 256 continually archives captured video and audio upon initialization and ceases the archiving process upon receipt of a stop command.

The archive process 256 produces one or more archive files that are stored in memory 282. The memory can be, for example, a hard disk. The archive process 256 can be configured to produce a single file for the entire archive duration, or may be configured to produce multiple files spanning the archive duration. The archive process 256 can generate, for example, multiple archive files that each represent no greater than a predetermined period of time. The multiple archive files can be logically linked to produce an archive that spans the aggregate length of the multiple archive files. Each of the archive files or the logically linked archive files represent a video clip that a user can request. The video clip can include corresponding audio or other data.

A clip CGI process 284 controls the retrieval and distribution of the stored video clips. The clip CGI process 284 can receive a request for a particular video clip from the main program. The clip CGI process 284 retrieves the requested video clip from the disk 282 and provides the video clip to the hardware in the host for broadcasting over a network 20 to a destination device.

The video/audio CGI 252 receives the captured video, audio, and other data that have been transformed into the common host format and distributes it to requesting users. The video/audio CGI 252 can, for example, format the captured streams into the proper communications format for distribution across the network 20 to users. The video/audio CGI 252 can be repeated for as many users as desire the captured video.

Destination devices connected to the network 20 can send rate and quality adjustment data that are received and processed by the adjustment CGI 286. The rate and quality adjustment data can automatically be sent by the destination device or can manually be initiated by the destination device. For example, the communication protocol used to send the video stream over the network 20 may incorporate a measure of quality of service that is returned to the adjustment CGI 286. Additionally, a number of dropped packets or resend requests may indicate a signal quality received by the destination device. Other data received by the adjustment CGI 286 may similarly indicate the need for a rate or quality adjustment. The adjustment CGI 280 sends the commands for rate or quality adjustments to the video capture process 280. The video capture process 280 can then adjust the process according to the received commands.

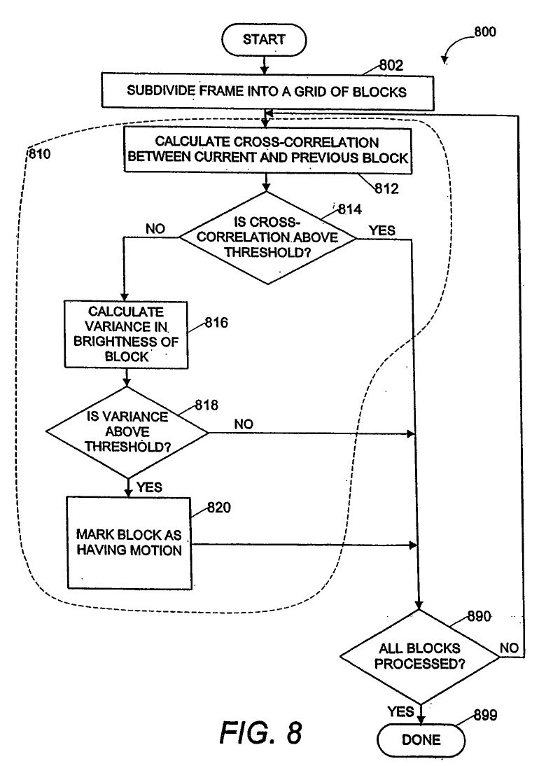

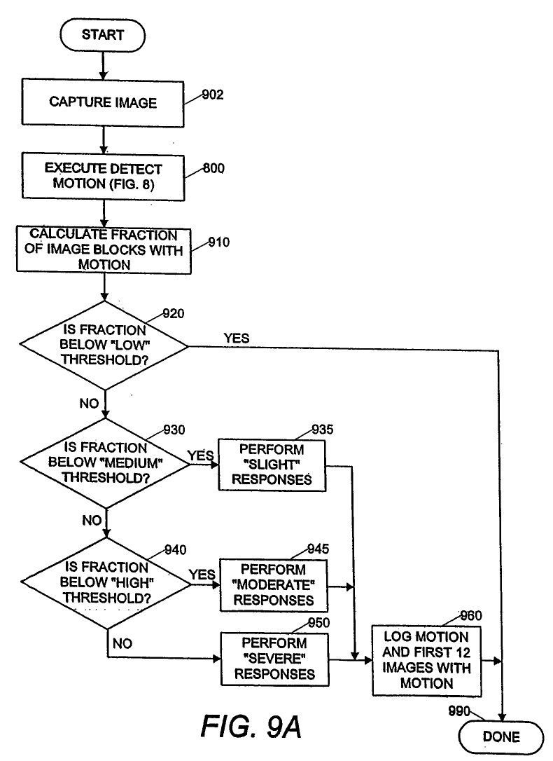

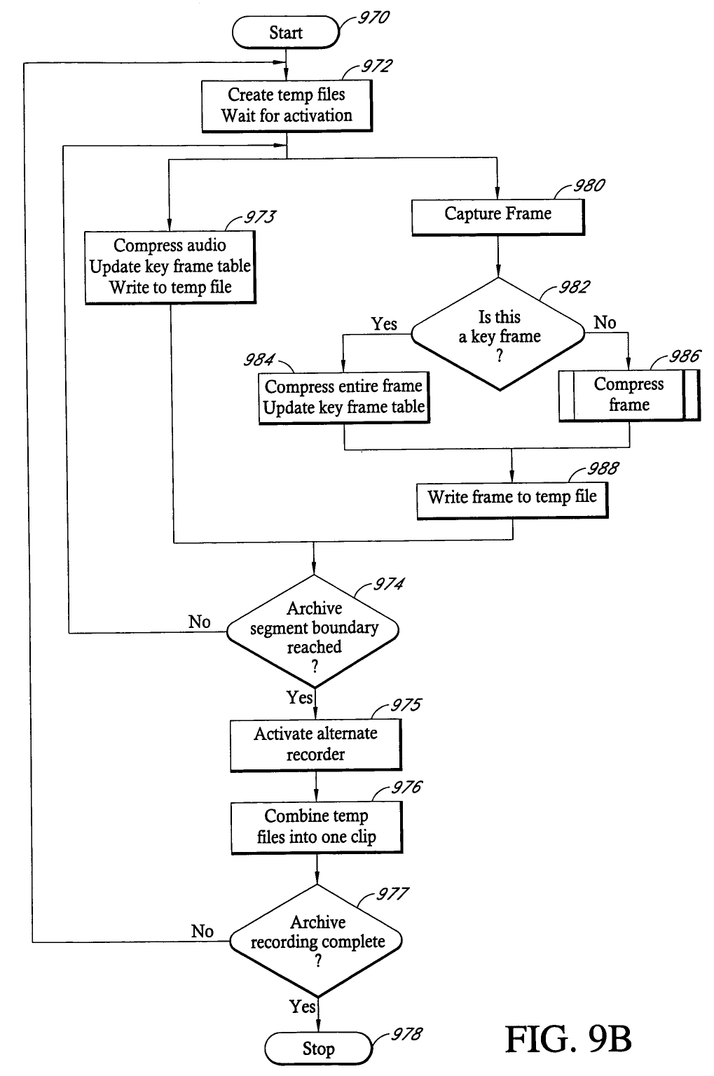

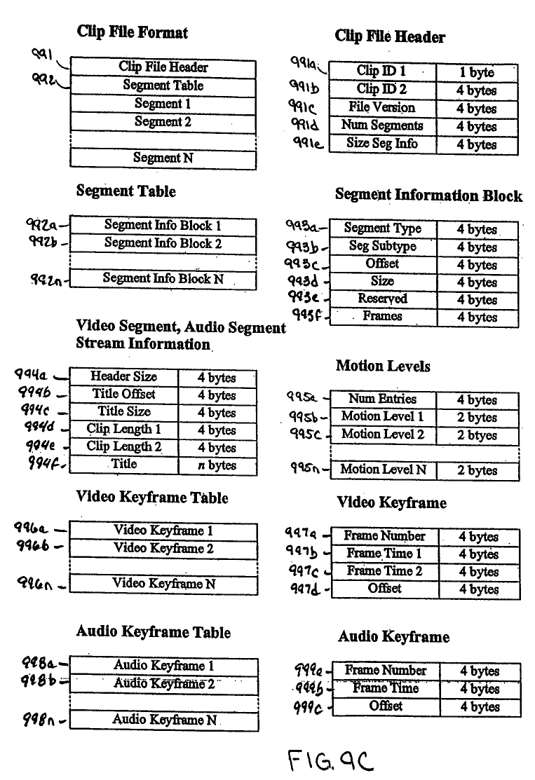

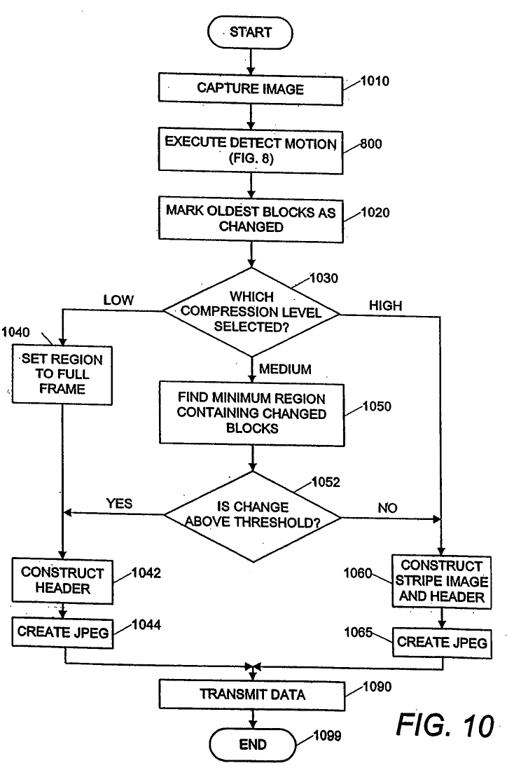

FIG. 2C is a process flow block diagram of a motion detection process, such as the motion detection process 240 of FIG. 2A. The motion detection process begins with images captured by the multi-media capture module 230. A video capture process 280 captures the images from an external device, such as a networked video camera, and transforms the image format into the common host image format. The captured images are provided to a motion detector process 242 that compares the most recently captured image to previously captured images in order to detect motion. One embodiment of the motion detection process is discussed in further detail below in association with FIGS. 8-10.

A control process 290 provides control commands to the detector process. The control commands may include, for example, start commands, stop commands, definitions of the portion of the image in which to perform motion detection, and motion detection thresholds. The control process 290 may accept user input and provide the control commands in response to the user input. Alternatively, the control process 290 may provide the control commands according to a predetermined script or sequence.

The motion detector process 242 can be configured to store a predetermined number of image frames or store images for a predetermined period of time in response to motion detection. The predetermined number of frames can be, for example, twelve image frames. The predetermined period of time for storing images can be, for example, five minutes. Of course the number of predetermined frames and the predetermined image period can be varied and can be varied in response to user input. If the motion detector process 242 detects motion, the motion detector process 242 stores the predetermined number of image frames or images over the predetermined period of time as one or more clips in disk 282. The image frames and image clips can be stored in disk 282 as one or more files.

The stored image files can be retrieved from memory 282 and communicated to a destination device by a motion detection CGI 246. The motion detection CGI 246 retrieves one or more image files from memory 282 and transforms the image file into the format corresponding to a type used by the destination device. The formatted images can then be communicated to a destination device, which may be a device connected to the network 20.

The motion detector process 242 may also initiate a motion response process 244 if motion is detected. The motion response process 244 may generate a predetermined alert and communicate the alert in response to motion detection. A predetermined alert can be, for example, an alarm trigger, an indicator alert, an email message to one or more predetermined addresses, or an alert message communicated to one or more devices. Additionally, the motion response process 244 can initiate one or more programs or processes.

The motion response process 244 can generate a sound alert and communicate the sound alert to a player in the operating system 249. For example, the motion response process 244 can initiate a sound player in the operating system to play a predetermined sound file. Additionally, the motion response process 244 can generate an email message and communicate the email message to a predetermined address on a network 20. Of course the motion response process 244 may generate other types of alerts and messages.

FIG. 2D is a process flow diagram of host administration. The video capture process 280 captures video from external devices and communicates the captured images to the control module 290. The video capture process 280 also monitors for license changes. The video capture process 280 also provides video to the FTP process 260. The FTP process can be configured to send captured images to a remote site, such as an FTP server connected to the network 20. Additionally, the FTP process 282 can store the captured images as files in memory 282.

The control module 290 operates as an overall system control module and also controls the user interface. The control module 290 controls the starting and stopping times of the video capture process 280 and also monitors user parameters, such as their IP addresses, and the bandwidth consumption of captured video sent to the users.

A resource monitor 292 is coupled to the control module 290. The resource monitor 292 monitors the system to ensure the server has the resources available to continue running all of the processes associated with the control module 290. In the event that the system becomes overloaded and does not look likely to recover, the resource monitor 292 can shut down the control module 290 and associated processes to avoid a system crash. Thus, the resource monitor 292 has the ability to start and stop the control module 290.

A Dynamic Domain Name System (DDNS) client 294 can be incorporated in the IP Proc module 60 of FIG. 2A. The DDNS client 296 monitors and updates the IP address of the host. The functions of the DDNS client 294 are described in further detail with respect to FIG. 14.

A web server, such as an Internet Web Server 296 operates to interface the system to a network, such as the Internet. The IWS 296 receives the requests from network users and processes them for use by the system. Additionally, the IWS 296 can generate responses to the requests, such as by communicating the objects required to build a web page view.

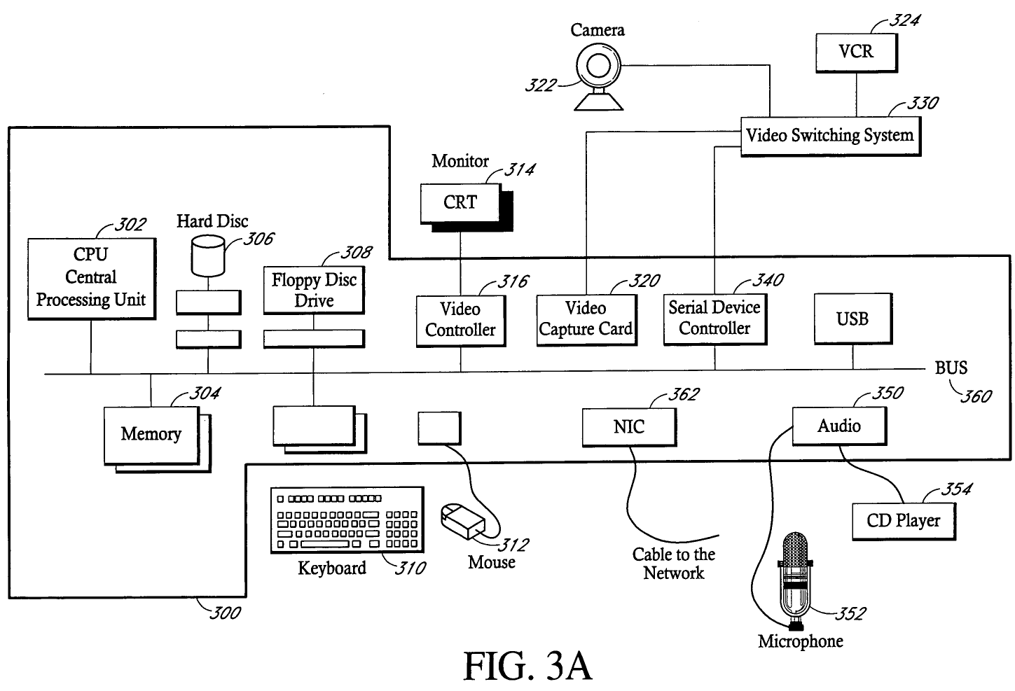

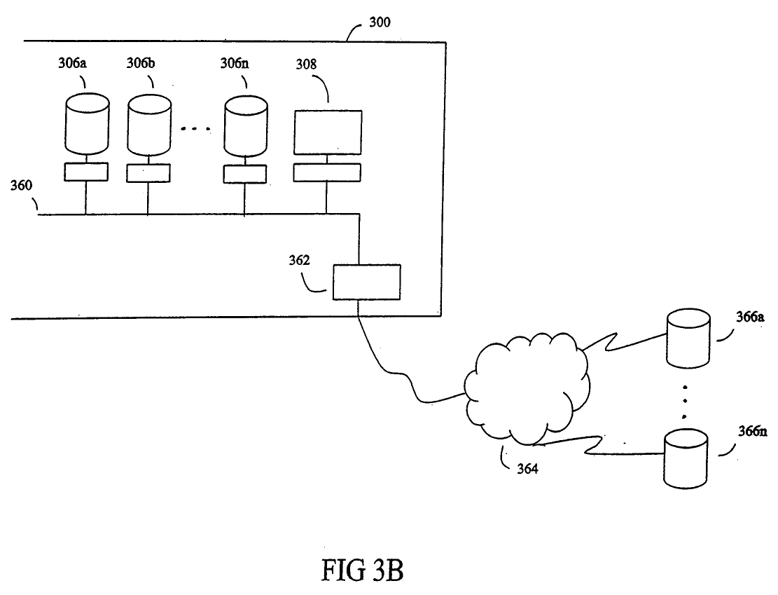

An example of a computer on which the host process resides is illustrated schematically in FIG. 3A. The block diagram of FIG. 3A shows the host implemented on a personal computer 300. The host process is stored as a collection of instructions that are stored in the personal computer 300. The instructions may be stored in memory 304, such as Read-Only Memory (ROM) or Random Access Memory (RAM), a hard disk 306, a floppy disk to be used in conjunction with a floppy disk drive 308, or a combination of storage devices. The instructions are executed in the Central Processing Unit (CPU) 302 and are accessed through a bus 360 coupling the storage devices 304, 306, 308 to the CPU 302. The bus 360 can include at least one address bus and one data bus, although multiple buses may also be used. User input is coupled to the personal computer 300 through a keyboard 310, a mouse 312 or other user input device. Images are displayed to the user through a monitor 314 that receives signals from a video controller 316.

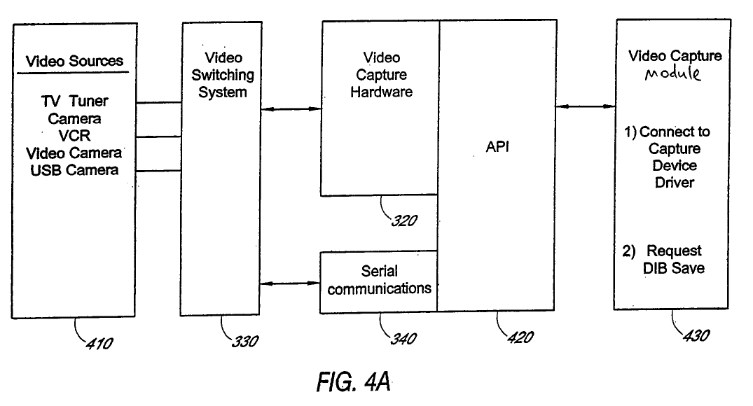

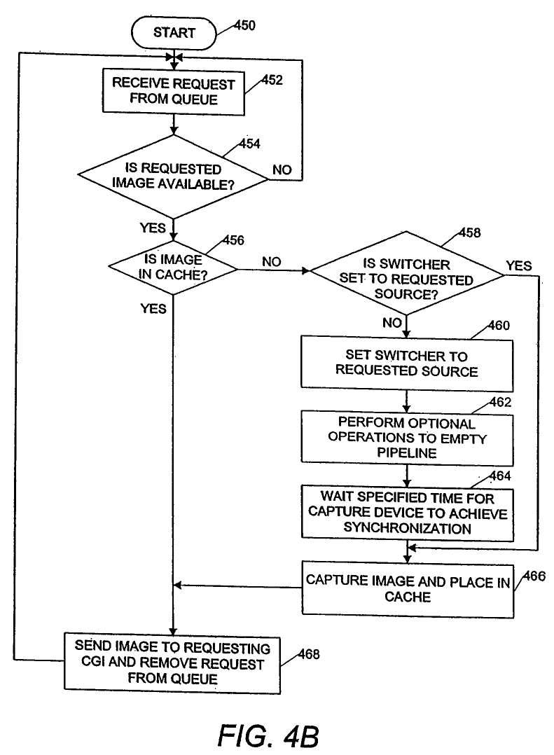

Video images are provided to the personal computer 300 from external video sources coupled to a video capture card 320. Although any video source may be used, a camera 322 and VCR 324 are shown in FIG. 3A. A video switching system 330 may be used to multiplex multiple video sources to a single video capture card 320. The video switching system 330 may be controlled through a serial device controller 340. The host process controls which video source is used to supply the input by controlling the video switching system 330. The video switching system 330 is described further in the patent application previously incorporated by reference and is described below with reference to FIG. 4B.

External audio sources may provide audio input to the personal computer 300. A microphone 352 and CD player 354 are shown as the external audio sources, although any audio source may be used. Audio is coupled from the external audio sources 352, 354 to the host process using an audio card 350.

The connection from the host to the network is made using a Network Interface Card (NIC) 362. The NIC 362 is an Ethernet card, but may be substituted with, for example, a telephone modem, a cable modem, a wireless modem or any other network interface.

FIG. 3B is a block diagram of an embodiment of a storage configuration that is coupled to and accessed by the personal computer 300. As described earlier with respect to FIG. 3A, an internal bus 360 within the personal computer 300 may be coupled to various internal storage devices. The personal computer 300 can include multiple internal hard disks 306a-306n as well as other storage devices 308. The other storage devices 308 can include, but are not limited to, disk drives, tape drives, memory cards, RAID drives, and the like, or some other means for storage.

Additionally, a NIC 362 can connect the personal computer 300 to an external network 364. The external network can be any type of communication network, such as a LAN or WAN. The WAN can be, for example, the Internet. The personal computer 300 can also be coupled to one or more remote storage devices 366a-366n accessible over the network connection. The remote storage devices 366a-366n are shown as hard disks, but can be any type of writable storage.

Images captured by a host process running on the personal computer 300 can be stored as files in any of the storage devices accessible to the personal computer 300. The archive module, such as module 56 of FIG. 1C or module 256 of FIG. 2B, can be configured to store files in any one of the writable storage devices. Additionally, the archive module can be configured to store files to the storage devices according to a predetermined hierarchy. When configuring the host process, a user can be shown a list of available storage devices. The user is also provided the capability of adding or deleting storage devices from the list. For example, when initializing the configuration shown in FIG. 3B, the host process may initially list only the local storage devices that are available. Thus, the host process would list the local disk drives 306a-306n as well as the other storage device 308, which can be a rewritable CD drive, for example. The user can then add other local or remote storage devices to the list. For example, a user may decide to add one or more remote storage devices 366a-366n to the list.

The archive module can also be configured via the host process to store files in the listed storage devices according to a predetermined order. For example, the user, through the host process, may define one or more locations on each storage device where files are to be stored. The locations within the storage devices can be, for example, logical folders or sub-directories within the storage devices. The host process treats each of the storage locations as a node, regardless of the type of storage device associated with the storage location. The host process can allow the user to name nodes. The user is also allowed to configure a threshold associated with each node. The threshold represents the allowable storage space assigned to that node. The threshold can be configured as an absolute memory allocation, such as a number of Megabytes of memory. Alternatively, the threshold can be configured relatively, such as by designating a percentage of available storage space. Thus, for example, a user may configure up to 90% of the available storage space on a particular node for file storage.

The host process also allows the user to select an order in which files will be written to the nodes. For example, a user may select a file in a first local disk drive 306a as the first node and may assign a threshold of 90% to that node. A sub-directory in a second local drive 306b may be assigned as the second node. The second node may be assigned a threshold of 75%. Additional nodes may be assigned until all available nodes are assigned a position in the storage order.

In one embodiment, the host process captures images and stores files to the nodes in the predetermined order. For example, the archive module under the host process will store files to the first node until the threshold assigned to the first node is reached. When the first node threshold is reached, the archive module will begin to store files in the second node. The archive module will continue to store files in subsequent nodes as the nodes reach the threshold values. When the last defined node reaches the defined threshold, the archive module attempts to store files according to the predefined node order, starting with the first node. The host process can also configure each threshold as a trigger event. The host process can, for example, generate a notification or alarm in response to a node reaching its threshold. The notification can be, for example a predefined email message identifying the node and time the threshold was exceeded. The host process can independently configure each notification or alarm triggered when each node reaches its assigned threshold.

As will be described later, files may be configured with a predefined expiration date. Thus, if sufficient storage exists, by the time the archive module attempts to store files in the first node, some of the originally stored files will have expired, providing more room for storage of new files. Of course additional storage space in a node can be created by deleting files previously stored in the node. In the condition that all nodes exceed the threshold values, the archive module has no available storage locations and cannot store the most recent file.

The ability to store data in remote nodes provides a level of security to the system. For example, archives can be stored remote from the host process, and thus, can minimize the possibility of the archive files being lost or destroyed in the event of a catastrophic event, such as a fire.

FIG. 4A is a diagram illustrating a process for video capture using an apparatus such as that shown in FIG. 3A. A video signal is generated in at least one video source 410. One video source may be used or a plurality of video sources may be used. A video switching system 330 is used when a plurality of video sources 410 is present. Each video source is connected to an input port of the video switching system 330. The video switching system 330 routes one of the plurality of input video signals to the video capture hardware 320 depending on the control settings provided to the video switching system 330 through a serial communications 340 link from the switcher 44 (see FIG. 1C).

Video sources such as a VCR, TV tuner, or video camera typically generate composite video signals. The video capture hardware 320 captures a single video frame and digitizes it when the video switching system 330 routes a video source outputting composite video signals to the video capture hardware 320. The system captures an image using an Application Program Interface (API) 420, such as Video for Windows available from Microsoft Corp. The API transmits the captured image to the video capture module 430.

FIG. 4B is a flow chart illustrating the function of the video switching module 330 shown in FIGS. 3 and 4A. The video subsystem maintains a cache of time stamped, video images for each video-input source. Requests for data are placed on a queue in the serial communications module 340. When the video switching module 330 receives a request from the queue (step 452), it first determines whether the requested image is available (step 454). The requested image may be unavailable if, for example, the image is in the process of being captured. If the image is not available, the process returns to step 452 and attempts to process the request again at step 454. If the requested image is available, the switching module 330 determines whether the image already exists in the cache (step 456). If the image exists in the cache, the switching module 330 sends the image to the requesting CGI 52a, 52b (see FIG. 1C) and removes the request from the queue (step 468). If the image does not exist in the cache, the switching module 330 proceeds to obtain the image. First, it determines whether the switcher is set to the source of the requested image (step 458). If the switcher is set to the proper source, the image is captured and placed in the cache (step 466). The image is then sent to the requesting CGI and the request is removed from the CGI (step 468). If the switcher is not set to the proper source, the switching module 330 causes a command to be sent to the switcher to switch to the source of the requested image (460). Next, depending on the video source and the capture device, optional operations may be performed to empty pipelines in the capture device's hardware or driver implementation (step 462). This is determined via test and interaction with the device during installation. The switching module 330 then waits a predetermined length of time (step 464). This delay allows the video capture device to synchronize with the new video input stream. The requested image is then captured and placed in the cache (step 466). The image is then sent to the requesting CGI, and the request is removed from the queue (step 468). Once the request has been removed, the switching module 330 returns to the queue to process the next request. Although the above description relates to the switching of video inputs, it may also apply to any switching module including, for example, the multimedia switcher 44 illustrated in FIG. 1C.

Audio signals are captured in a process (not shown) similar to video capture. Audio sources are connected to multimedia audio hardware in the personal computer. The audio capture module makes periodic requests through an API such as Windows Multimedia, available from Microsoft Corp., for audio samples and makes the data available as a continuous audio stream.

The host 10 (see FIGS. 1A-C) distributes the multimedia data to requesting clients once the multimedia data has been captured. As noted above, the host is configured as a web server 50 in order to allow connections by numerous clients runs the host multimedia distribution application.

The client 30 can be a remote hardware system that is also connected to the network. The client may be configured to run a Java-enabled browser. The term “browser” is used to indicate an application that provides a user interface to the network, particularly if the network is the World Wide Web. The browser allows the user to look at and interact with the information provided on the World Wide Web. A variety of commercially available browsers are available for computers. Similarly, compact browsers are available for use in portable devices such as wireless phones and personal digital assistants. The features available in the browser may be limited by the available processing, memory, and display capabilities of the hardware device running the browser.

Java is a programming language developed especially for writing client/server and networked applications. A Java applet is commonly sent to users connected to a particular web site. The Java archive, or Jar, format represents a compressed format for sending Java applets. In a Jar file, instructions contained in the Java applet are compressed to enable faster delivery across a network connection. A client running a Java-enabled browser can connect to the server and request multimedia images.

Wireless devices may implement browsers using the Wireless Application Protocol (WAP) or other wireless modes. WAP is a specification for a set of communication protocols to standardize the way that wireless devices, such as wireless phones and radio transceivers, are used for Internet access.

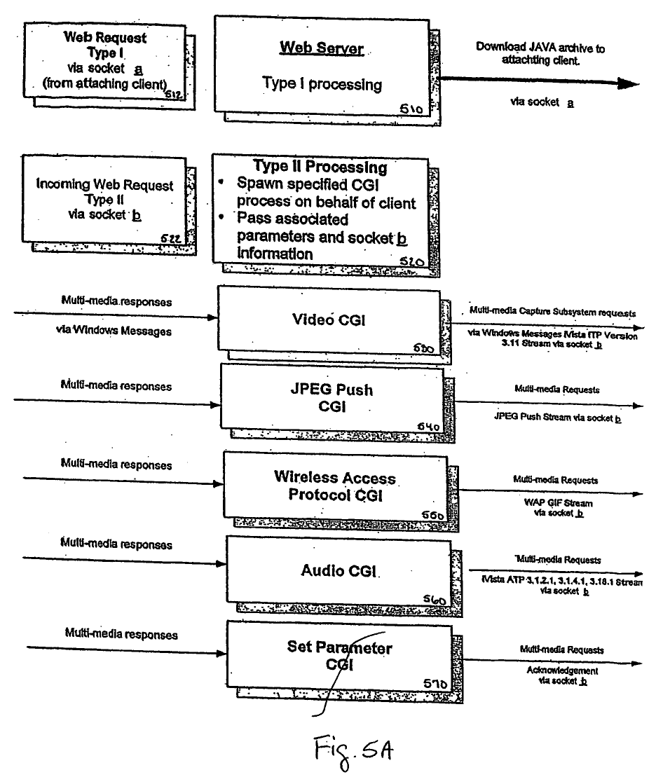

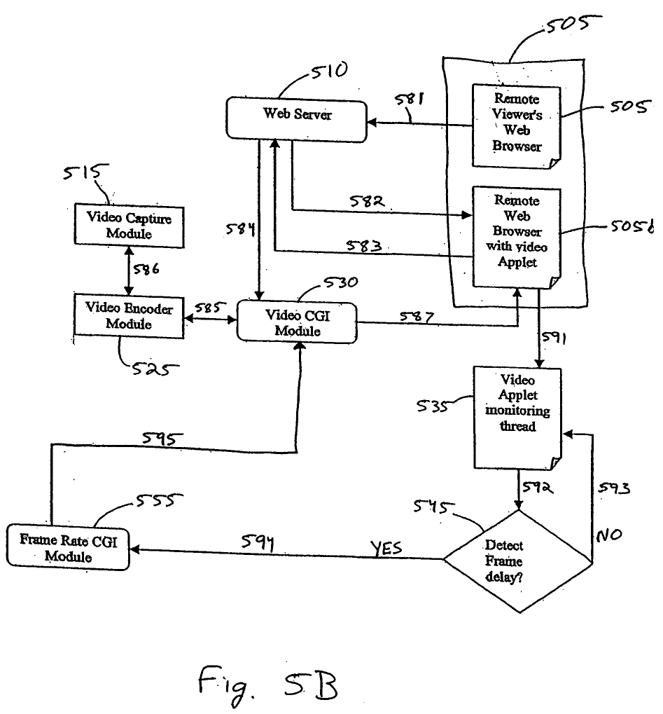

Referring to FIGS. 1 and 5A, a client 30 initially connecting via the network 20 to the host makes a web request, or Type I request 512, while logged on a website. As used herein, the term “website” refers to one or more interrelated web page files and other files and programs on one or more web servers. The files and programs are accessible over a computer network, such as the Internet, by sending a hypertext transfer protocol (HTTP) request specifying a uniform resource locator (URL) that identifies the location of one of the web page files. The files and programs may be owned, managed or authorized by a single business entity or an individual. Such files and programs can include, for example, hypertext markup language (HTML) files, common gateway interface (CGI) files, and Java applications.

As used herein, a “web page” comprises that which is presented by a standard web browser in response to an HTTP request specifying the URL by which the web page file is identified. A web page can include, for example, text, images, sound, video, and animation.

The server performs Type I processing 510 in response to the Type I request 512 from the client. In Type I processing, the server opens a communication socket, designated socket “a” in FIG. 5A, and sends a Jar to the client. The first communication socket, socket “a,” is closed once the Jar is sent to the client. The client then extracts the Jar and runs it as a video applet once the entire Jar arrives at the client system. Alternatively, the functionality of the video applet can be implemented by software or firmware at the client.

The video applet running on the client system makes a request to the server running on the host. The request specifies parameters necessary for activation of a Common Gateway Interface (CGI) necessary for multimedia distribution. The video applet request may supply CGI parameters for video source selection, frame rate, compression level, image resolution, image brightness, image contrast, image view, and other client configurable parameters. The specific parameters included in the request can be determined by the button or link that was selected as part of the Type I request. The web page may offer a separate button or link for each of several classes of clients. These classes refer to the capability of clients to receive data in specific formats and at specific rates. For example, one button may correspond to a request for the data at a high video stream rate (30 frames per second) while another button corresponds to a request for the data in simple JPEG (single frame) format. Alternatively, the video applet can survey the capabilities of the client system and select appropriate parameters based upon the results of the survey, or the video applet can respond to user input.

The server receives the video applet request and, in response, establishes a communication port, denoted socket “b,” between the server and the client. The server then launches a CGI using the parameters supplied by the video applet request and provides client access on socket “b.” The video CGI 530 established for the client then sends the formatted video image stream over the socket “b” connection to the video applet running on the client. The video applet running on the client receives the video images and produces images displayed at the client.

The applet may be configured to perform a traffic control function. For example, the client may have requested a high stream rate (e.g., 30 frames per second) but may be capable of processing or receiving only a lower rate (e.g., 10 frames per second). This reduced capability may be due, for example, to network transmission delays or to other applications running on the client requiring more system resources. Once a transmission buffer memory is filled, the server is unable to write further data. When the applet detects this backup, it submits a request to the server for a reduced stream rate. This request for change is submitted via, for example, a “set parameter” CGI 570, or a frame rate CGI, which is described in further detail below with reference to FIG. 5B.

To detect a backup, the applet can compare a timestamp embedded in each frame (described below with reference to FIG. 6) with the client's internal clock, for example. By detecting a change in the relative time between consecutive frames, the applet is able to recognize the backup and skip processing of delayed frames. Thus, the client proceeds to process the current frame rather than an old frame. For example, if the client receives 30 frames per second and can only process one frame per second, the applet will cause the client to process the first frame, skip the next 29 frames and process the 31st frame.

The client can also select to view only a portion of the image. For example, the client may select a region of the image that he wishes to magnify. The applet allows the client to submit a request to the CGI to transmit only blocks corresponding to the selected region. By selecting only the selected blocks, the necessary bandwidth for transmission is further reduced. Thus, the client can zoom to any region of the captured image. As a further example, the client may submit a request, via the applet, to pan across the image in any direction, limited only by the boundaries of the captured image. The applet submits this request as a change in the requested region.

Each time a video frame or audio block is encoded in the server, it is available to be transmitted to the client. The video CGI 530 determines, according to the parameters passed by the video applet, whether to submit a request for an additional video frame and whether to send the additional information to the client.

A similar audio CGI 560 is established using an audio applet running on the client. Each time an audio block is encoded at the server, it is available to be transmitted to the client. The audio CGI 560 transmits the audio information to the client as a continuous stream.

The applet may be configured to perform an audio traffic control function similar to that described above with respect to the video CGI 530. For example, the client may have initially requested an 8-bit audio stream but may be capable of only handling a 4-bit or a 2-bit stream.

2-bit and 4-bit audio streams are encoded based on adaptive pulse code modulation encoding (ADPCM) as described by Dialogic Corporation. The 4-bit audio samples are generated from 16-bit audio samples at a fixed rate. The 2-bit audio encoder modifies the standard ADPCM by removing the two lowest step bits, resulting in 2-bit samples from the original 16-bit data. An 8-bit stream is generated by converting 16-bit samples into 8-bits using a μ-law encoder which is utilized in the Sun Microsystems, Inc. audio file format. This encoder is defined as the ITU-T standard G.711.

When the applet detects a discrepancy between the transmitted audio data and the capabilities of the client, it submits a request for change to the server. The audio CGI 560 then closes the audio stream and reopens it at the appropriate data rate.

As noted above, the client determines the type of CGI that controls the information flowing to it on socket b by making the appropriate request. In the case of a JPEG Push CGI 540 or a Wireless Access Protocol (WAP) CGI 550, no applet is involved and no socket “b” is established. For example, if the client is an Internet-enabled wireless device utilizing a WAP browser, a video CGI 530 is not set up. Instead, a WAP-enabled device requests a WAP CGI 550 to be set up at the server. Video frames are then routed to the WAP-enabled device using the WAP CGI in lieu of the video CGI 530 via socket “a”. The video frames are routed to the client as JPEG files. Similarly, a JPEG Push CGI 540 is set up at the server if the client requests JPEG Push. In response to a request by a client, the web server 510 establishes a separate socket b connection to the server and utilizes a separate CGI that is appropriate for its capabilities, for that particular client.

An additional CGI that utilizes a socket is the “set parameter” CGI 570. A client may revise the parameters that control the received images and audio by adjusting controls that are available on the video applet. When the client requests a change in parameters the “set parameter” CGI 570 is launched to change the parameters at the server. It can be seen that each individual client may change the CGI settings associated with that particular client without affecting the images or audio being sent to any other client. Thus, each individual client has control over its received multimedia without affecting the capture process running on the server system.

FIG. 5B is a block diagram illustrating the streaming of the video data by the host to clients and the flow of commands and information between components of the host and the client. The video streaming begins when the client, via the remote user's web browser 505a, sends a request (indicated by line 581) to the host server system 510. In one embodiment, the request is an HTTP request. In response to the request, the server system 510 sends (line 582) a Jar to the client's web browser 505. The Jar includes an applet that is launched by the client's web browser 505. Although FIG. 5B indicates the web browser 505 as having two blocks 505a, 505b, it is understood that the two blocks 505a, 505b only illustrate the same browser before and after the launching of the applet, respectively. Among other functions, the applet then sends a request to the web server 510 for the web server 510 to launch a CGI (line 583). Additionally, the applet causes the client to send client-specific parameters to the web server 510. In response to the request, the web server 510 establishes a socket and launches a CGI 530 according to the parameters supplied by the client and information associated with the socket (line 584). The CGI 530 submits periodic requests for video information to a video encoder 525 (line 585). The video encoder 525 receives JPEG-encoded video data from a video capture module 515 and formats the data for streaming, as described, for example, below with reference to FIGS. 6 and 7 (line 586). The encoder 525 responds to the requests from the CGI 530 by transmitting the encoded video information to the CGI 530 (line 585). The video encoder module 525 and the video CGI module 530 may be sub-modules in the video CGI 52a shown in FIG. 1C. The CGI 530 transmits the encoded video frames to the applet over the established socket (line 587). The applet decodes the encoded audio frames, providing audio to the user.

As noted above, the applet may be configured to perform a traffic control function. When the applet is launched on the remote viewer's browser 505b, it may launch a frame-rate monitoring thread 535 (line 591). The thread 535 monitors the video stream for frame delays (step 545) by, for example, comparing time stamps of video frames with the client's internal clock, as described above. As indicated in FIG. 5B, the video applet continuously checks for frame delays (line 593). When a frame delay is detected (line 594), the applet requests that the web server 510 launch a frame-rate CGI 555. The request also submits parameters to indicate the frame rate capabilities of the client. The parameters are submitted to the video CGI 530 (line 595) which changes the rate at which video is streamed to the user.

The video CGI compresses and formats the video images for streaming in order to reduce the required network bandwidth. The video applet running on the client extracts the video image from the compressed and encoded data. A block diagram of the video stream format is shown in FIG. 6. The video stream can be formatted in several ways with each format transmitting separate video image information. All video stream formats are comprised of a single six-byte header 602 followed by a number of video blocks 604a-604nn.

In the embodiment of FIG. 6, the six-block header 602 is made up of a one-byte error code 610, a one-byte source 612, and a four-byte connection ID 614. The one-byte error code 610 indicates whether an error is present in the transmission. A zero value error code 610 indicates a successful transmission follows. A non-zero error code indicates an error has been detected and no data blocks will follow. The non-zero error code 610, therefore, indicates the data stream is complete. The one-byte source 612 indicates the origin of the video image. A zero value source 612 indicates the host as the source of the video image. A one in the source 612 indicates the image is coming from a mirror site. The use of a mirror site is discussed in detail below. Use of a mirror site is not otherwise detectable by the client and does not degrade the image received at the client. The four-byte connection ID 614 is used to designate the specific client. The connection ID 614 is an identifier that is unique to each connected user.

A series of video blocks 604 follow the header 602. Different video block formats are used to transmit different size video images. However, in one embodiment, all video block formats utilize a structure having a four-byte frame size field 620 followed by a four-byte block type field 622, followed by block data fields 624.

A first type of video block 604 is defined as block type N, where N represents a positive integer defining the number of image segments encoded in the block. A block type N format utilizes a data triplet to define each of N video segments. Each of the N data triplets contains a four-byte X position field 632, a four-byte Y position field 634, and a four-byte width field 636. The X and Y positions define the location of the segment on the client screen. The width field 636 defines the width of the video segment. The height of the video segment for the block type N video format is preset at sixteen pixels. Thus, each of the data triplets defines a video image stripe that is displayed on the client screen. Following the N data triplets, the block type N video format utilizes a series of data blocks. A four-byte data offset field 640 is used to facilitate faster transmission of data by not transmitting identical bytes of data at the beginning of each image. For example, two consecutive images may have the identical first 600 bytes of data. The data offset field 640 will be set to 600 and will prevent retransmission of those 600 bytes.

A Data Size (DS) field 642 follows the data offset field 640 and is used to define the size of the data field that follows. Two four-byte timestamp fields 644, 646 follow the DS field 642. The first timestamp field 644 is used to timestamp the video image contained in the block type N image. The timestamp 644 may be used to update a timestamp that is displayed at the client. The second timestamp field 646 is used to synchronize the video stream with an audio stream. The contents of the DS field 642 define the number of data bytes in the data field 648 that follows the timestamp fields 644 and 646. The information in the data field 648 is JPEG encoded to compress the video image. Thus, each data triplet defines the location and width of a JPEG encoded video image stripe. The image is a single video stripe in the image when all of the segments are in the same Y coordinate. The initial segment 650a is a sixteen-pixel-high segment having a width defined in the first data triplet. Similarly, subsequent segments 650b-650n are sixteen-pixel-high segments with widths defined by the width field 636b-636n of the corresponding triplet.

Another video block type is denoted block type −3 and is also known as a Single Block type. The structure of the Single Block is shown in FIG. 7. The Single Block format begins with a pair of four-byte data fields. The first four-byte data field provides the initial horizontal location, X₀ 710. The second four-byte block provides the initial vertical location, Y₀ 712. The coordinates X₀ 710 and Y₀ 712 define the upper left corner of the video image provided in the Single Block. A second pair of four-byte data fields follows the first pair. The second pair of data fields define the lower right corner of the video image provided in the Single Block. The first data field in the second pair provides the final horizontal position, X₁ 714, and the second data field in the pair provides the final vertical position, Y₁ 716. A four-byte Data Offset field 718 follows the two pairs of coordinates. A Data Size (DS) field 720 follows the Data Offset field 718 and is used to define the number of bytes in the data field 726. Immediately following the DS field 720 are two four-byte timestamp fields 722 and 724 to identify the time the video image was generated. The video applet running on the client can extract the timestamp information in order to overlay a timestamp on the image. The Single Block is completed with a data field 726 consisting of the number of data blocks defined in the DS field 720. Thus, the Single Block type defines a rectangular video image spanning the coordinates (X₀, Y₀)-(X₁, Y₁).

Block type −4, also designated a Synchronization Frame, has a data format identical to that of the above-described Single Block. In the Synchronization Frame, the initial horizontal and vertical coordinates, X₀ and Y₀, are set to zero. Setting the initial coordinates to zero aligns the upper left corner of the new image with the upper left corner of the existing image. The final horizontal and vertical coordinates in the Synchronization Frame correspond to the width of the whole image and the height of the whole image, respectively. Therefore, it can be seen that the Synchronization Frame can be used to refresh the entire image displayed at the client. The Synchronization Frame is used during the dynamic update of the video frame rate in order to limit transmission delays, as described above with reference to FIG. 5B.

Block type −1 does not contain any image data within it. Rather it is used to indicate a change in the transmitted image size. The block type −1 format consists of a four-byte data field containing the New Width 740, followed by a four-byte data field containing the New Height 742. The block type −1 information must be immediately followed by a full-image Single Block or Synchronization Frame.

Finally, block type −2 is designated the Error Block. The Error Block consists solely of a one-byte Error Code 750. The Error Block is used to indicate an error in the video stream. Transmission of the video stream is terminated following the Error Code 750.

Referring now to FIG. 8, motion detection, which can be carried out by the host, will be described. Once the image has been captured into a JPEG-encoded frame, for example, the contents of a frame can further be processed by the main program module 46 (see FIG. 1C) as follows. Data from subsequent video frames can be compared to determine whether the frames capture motion. FIG. 8 shows a flow chart of the motion detection process. A JPEG-encoded frame is received from the video capture module 40a by the main program module 46 (see FIG. 1C). The frame is first subdivided into a grid of, for example, 16 blocks by 16 blocks in order to detect motion within sequential images (step 802). Motion can be detected in each individual block. The number of blocks used to subdivide the frame is determined by the precision with which motion detection is desired. A large number of blocks per frame increases the granularity and allows for fine motion detection but comes at a cost of processing time and increased false detection of motion due to, for example, jitter in the image created by the camera or minute changes in lighting. In contrast, a lower number of blocks per frame provides decreased resolution but allows fast image processing. Additionally, the frame may be the complete image transmitted to the clients or may be a subset of the complete image. In other words, motion detection may be performed on only a specific portion of the image. The host user may determine the size and placement of this portion within the complete image, or it may be predetermined.

Once the frame has been subdivided, each block in the grid is motion processed (referenced in FIG. 8 as 810). Motion processing is performed on each block using comparisons of the present image with the previous image. First, at step 812, a cross-correlation between the block being processed of the current image and the corresponding block of the previous image is calculated. In one embodiment, the cross-correlation includes converting the captured blocks to grayscale and using the gray values of each pixel as the cross-correlated variable. Alternatively, the variable used for cross-correlation may be related to other aspects of the image such as light frequency of pixels.

At step 814, the cross-correlation is then compared with a predetermined threshold. The predetermined cross-correlation threshold can be a static value used in the motion detection process or it can be dynamic. If the cross-correlation threshold is dynamic, it may be derived from the size of the blocks or may be set by the host user. The host user may set the cross-correlation threshold on a relative scale where the scale is relative to a range of acceptable cross-correlation values. Use of a relative scale allows the host user to set a cross-correlation threshold without having any knowledge of cross-correlation. It may be preferable for the cross-correlation threshold to be set higher when the block size is large. In contrast, a lower cross-correlation threshold may be preferable where the block size is small and there are not many pixels defining the block. In addition, the cross-correlation threshold can be set in accordance with the environment in which the system operates (e.g., outdoor versus indoor) and the particular use of the motion detection (e.g., detecting fast movement of large objects).

If, at step 814, the cross-correlation threshold is not exceeded (i.e., the blocks are sufficiently different), the process next calculates the variance in the brightness of the block over the corresponding block of the previous image (step 816). The variance is compared against a variance threshold at step 818. Again, the variance threshold may be static or dynamically determined. If the calculated variance falls below the variance threshold then no motion is indicated in the block, and the process continues to step 890. The block is not marked as one having motion. However, if the variance exceeds the variance threshold, the block is marked as having motion at step 820, and the process continues to step 890.

On the other hand, if the calculated cross-correlation is above the predetermined threshold at step 814 (i.e., blocks are sufficiently similar), then no motion has been detected, and the process continues to step 890. The block is not marked as one having motion. In an alternate embodiment, the brightness variance may be calculated and compared to a variance threshold. Thus, brightness variances alone may be sufficient to detect motion. However, to reduce the number of false positives, the preferred embodiment illustrated in FIG. 8 requires both a sufficient variance in brightness and in the cross-correlation variable.

At step 890, the routine checks to see if all blocks have been processed. If all blocks have been processed, the motion detection routine in the main program 46 terminates (step 899) and returns the results to the video capture module 40a shown in FIG. 1C. However, if not all blocks of the current image have been processed, the routine returns to motion processing (reference 810) to analyze the next block.

FIG. 9 shows a flow chart of the motion detection process performed by the main program 46 (see FIG. 1 C) on a frame level. Motion detection requires comparison of at least two frames, one of which is used as a reference frame. Initially, a first frame is captured and used as the reference frame for determining motion detection (step not shown in FIG. 9). The first step in detecting motion is capture of the current frame (step 902). Motion detection (step 800) on the block level, as described above with reference to FIG. 8, is performed on the captured frame using the initial frame as the reference. Following motion detection on the block level (step 800), the motion detection process calculates the fraction of blocks that have motion (step 910). The calculated fraction is compared against “low,” “medium,” and “high” thresholds. The thresholds may be static or dynamic as described above for the thresholds in the block motion detection process (step 800).

If, at step 920, the calculated fraction falls below the “low” threshold, then no motion has been detected in the frame, and the detection process proceeds to step 990. However, if the calculated fraction exceeds the lowest threshold then the fraction must lie within one of three other ranges, and the process continues to step 930.

At step 930, the calculated fraction is compared against the “medium” threshold. If the calculated fraction does not exceed the “medium” threshold (i.e., the fraction is in the low-medium range), the process continues to step 935. At step 935, the motion detection process performs “slight” responses. Slight responses may include transmitting a first email notification to an address determined by the host user, sounding an audible alert, originating a phone call to a first number determined by the host user, or initiating predetermined control of external hardware, such as alarms, sprinklers, or lights. Any programmable response may be associated with the slight responses, although advantageously, the lowest level of response is associated with the slight response. After performing the “slight” responses, the process continues to step 960.

If, at step 930, the calculated fraction exceeds the “medium” threshold, the process continues to step 940. At step 940, the calculated fraction is compared against the “high” threshold. If the calculated fraction does not exceed the “high” threshold (i.e., the fraction is in the medium-high range), the process continues to step 945. At step 945, the motion detection process performs moderate responses. Moderate responses may include any of the responses that are included in the slight responses. Advantageously, the moderate responses are associated with a higher level of response. A second email message may be transmitted indicating the detected motion lies within the second range, or a second predetermined phone message may be directed to a phone number determined by the host user. After performing the “moderate” responses, the process continues to step 960.

If, at step 940, the calculated fraction exceeds the “high” threshold (i.e., the fraction is in the high range), the process continues to step 950. At step 950, the motion detection process performs severe responses. Advantageously, the most extreme actions are associated with severe responses. The severe responses may include transmitting a third email message to a predetermined address, originating a phone call with a “severe” message to a predetermined phone number, originating a phone call to a predetermined emergency phone number, or controlling external hardware associated with severe responses. External hardware may include fire sprinklers, sirens, alarms, or emergency lights. After performing the “severe” responses, the process continues to step 960.

At step 960, the motion detection process logs the motion and the first twelve images having motion regardless of the type of response performed. The motion detection threshold is, in this manner, used as a trigger for the recording of images relating to the motion-triggering event. The images are time-stamped and correlate the motion triggering event with a time frame. Motion detection using this logging scheme is advantageously used in security systems or any system requiring image logging in conjunction with motion detection. The motion detection process is done 940 once the twelve motion images are recorded. The motion detection process may be part of a larger process such that the motion detection process repeats indefinitely. Alternatively, the motion detection process may run on a scheduled basis as determined by another process. Although the foregoing example utilizes low, medium and high thresholds, fewer or more thresholds can be used.

Additional advantages may be realized using block motion detection in conjunction with the different image encoding formats shown in FIG. 6 and FIG. 7. Transmitting a complete video image to a client requires a great deal of network bandwidth even though the image may be JPEG-encoded. The amount of network bandwidth required to transmit images to a client can be reduced by recognizing that subsequent data within an image remains the same for a majority of images. Only a small fraction of the image may include data not previously transmitted to the client in a previous image. Transmitting only those images that change from image frame to image frame can reduce the network bandwidth requirement. The client is not aware that the entire image is not retransmitted each time because those blocks that are not retransmitted contain no new information.

Alternatively, or in addition to logging discrete images in response to motion detection, a motion detection process can be configured to record captured images and audio in a clip file that is stored in memory. In another embodiment, captured images and audio can be recorded as clip files independent of the motion detection process. Thus, a user can configure the system to capture and record images continuously, according to a predefined schedule, in response to manual commands, or in response to a motion detection event.

A user may configure the host to record captured images for one or more cameras and can record images from one or more cameras in response to detecting motion in images one of the cameras. Additionally, because a video source, such as a video input or a computer display, can be used as an image source for motion detection, recording can commence in response to motion detection in a computer screen. Such motion detection may occur, for example, if the computer is used after being dormant for a period of time.

Additionally, the host can allow the user to select different record settings for different cameras. Global record settings may be applied to all cameras in a view or each individual camera or video source can be configured with its own record settings. The user may also configure the host to record images from multiple cameras in response to motion detection in any one of the camera images. The host may provide a “hot record” or “snap record” control in the camera views. The user at the client can then immediately begin recording events by selecting the “snap record” control. This immediate record capability allows the user to control image recording at the host without needing to navigate through a set up and configuration process. This allows a user at the client to record immediate images of interest.

The clip files can be stored in memory for a predetermined period of time and overwritten by the system after the predetermined period of time has elapsed. Allowing recorded clip files to expire after a predetermined period of time allows memory, such as disk space, to be conserved.

FIG. 9B is a flow chart illustrating image and audio recording. The archival module 256, for example, can perform image and audio recording. The process begins at block 970 and proceeds to block 972 where the host creates a temp file and awaits activation of the clip recorder. The clip file can be stored, for example in a hard disk on the host. The temp file can also be created on the hard disk or can be created in some other type of memory that can be written and read, such as RAM, NVRAM, EEPROM, or some other type of writable memory. As noted earlier, the clip recorder can be activated upon a number of events. As will be discussed in further detail below, the clip recorder can be activated by another clip recorder.

Once the clip file is activated, the host proceeds to two independent paths and performs the functions described in both paths. At block 980, the host captures the frame. The host can use, for example, the modules and hardware described in FIG. 1C and the processes and modules described in FIG. 2B to perform image capture. The captured video can be, for example, compressed in the format discussed in FIGS. 6 and 7.

The host next proceeds to decision block 982 where it determines if the captured image is a key frame. The compression format discussed with respect to FIGS. 6 and 7 can minimize storage and transmission requirements by tracking the changes in the captured images from frame to frame. Thus, each frame can be reconstructed by having knowledge of the immediately preceding raw frame. However, some captured images may change very little from frame to frame. Other captured images may change very little in some portions of the frame. In extreme conditions of an extended clip file, an image near the end of the clip file may require building the image from the initial captured full frame image. This may present difficulties where clip files may contain images captured over 24 hours of time and a viewer is only interested in the images near the end of the clip file. In order to limit the number of frames that need to be reconstructed prior to constructing a desired image, key frames are periodically recorded. Key frames represent full frame images that can be periodically captured and saved to limit the number of frames that a viewer must reconstruct prior to constructing any particular frame.

The insertion of key frames can increase the amount of storage space required to record a clip file. Thus, the key frame frequency is a tradeoff between the limitation on frames that need to be reconstructed prior to constructing any particular frame and the need to conserve storage space. The key frame can thus be inserted at a predetermined number of frames. The predetermined number of frames can be a constant or can vary. The predetermined number of frames can depend on the captured images or can be independent of the captured images. For example, a key frame can occur every 25 frames or can occur 25 frames following a full frame with no other intervening full frame. Alternatively, a key frame may occur every 10, 20, 30, 40 frames or some other increment of frames. It may be convenient to use a fixed number of frames between key frames such that the occurrence of a key frame can be distinctly correlated to a time in the clip file.

If the captured frame is a key frame, the host proceeds to block 984 where the entire frame is compressed. The host also updates a key frame table, listing, for example, the locations and times of key frames. The host next proceeds to block 988.

Returning to decision block 982, if the captured frame is not a key frame, the host proceeds to block 986 and the frame is compressed. The host then proceeds to block 988.

In block 988, the host writes the frame, whether a key frame or a compressed frame, to the temp file previously created in block 972. The host proceeds from block 988 to block 974.

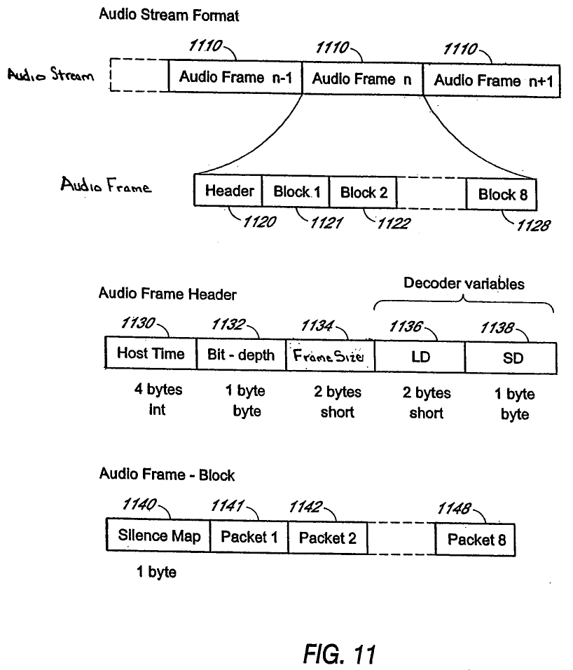

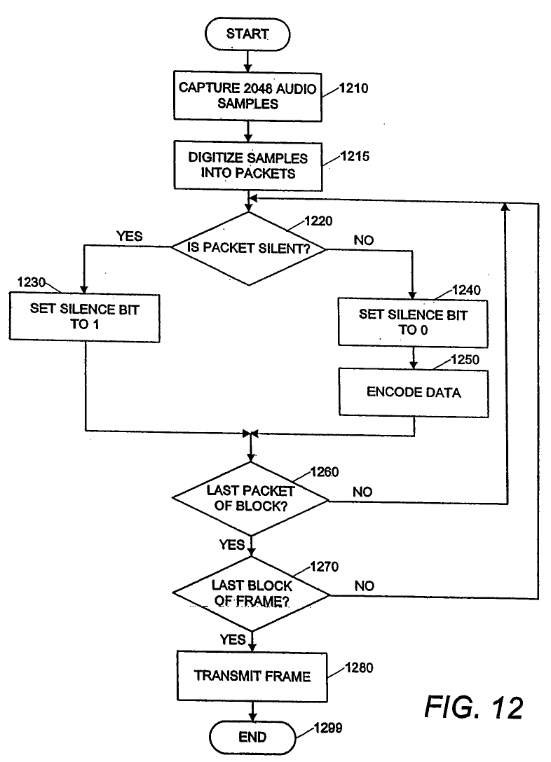

Returning to block 972, the host proceeds to a second path to record the captured audio that accompanies the captured video. The host proceeds from block 972 to block 973. However, if there is no audio accompanying the video, such as if the video camera lacks an associated audio signal, block 973 is omitted. In block 973, the host compresses the audio signal using an audio compression algorithm, updates an associated key frame table, and writes the compressed audio to the temp file. FIGS. 11 and 12 discuss audio compression in further detail. The host proceeds from block 973 to decision block 974.

In decision block 974, the host determines if an archive segment boundary has been reached. The stored clip files can be as long as memory allows. In a configuration in which the system is used as a security monitor, the clip files may routinely store 24 hours of captured images and audio. In order to reduce the file size of any particular clip file, the size of a clip file is limited to storing images for a predetermined amount of time. The host can logically link multiple clip files to form a seamless clip file of any desired duration. An individual clip file can be limited, for example to a five minute duration. Alternatively, the individual clip files can be limited to 1, 2, 4, 5, 10, 30, 60, 120 minutes or some other file size limit.

If an archive segment boundary has not been reached, the host returns to blocks 980 and 973 to continue to capture, compress, and store the video and associated audio. If an archive segment boundary has been reached, that is the end of the clip file boundary has been reached, the host proceeds from decision block 974 to block 975.

At block 975, the host activates an alternate recorder. The host may not be able to generate the archive clip file from the temp file prior to the arrival of the next captured frame. For example, the host may be configured to capture 25 or 30 frames per second and the host may be unable to generate the clip file from the temp file prior to the occurrence of the next frame. To accommodate the time required to generate the clip file, the host activates an alternate recorder that operates according to a process that is similar to the one shown in FIG. 9B. Thus, while a first clip recorder is generating a clip file, a second clip recorder continues to capture and store video and audio. The first clip recorder then waits until the second clip recorder has reached a segment boundary and is activated while the second clip recorder generates another clip file.

Once the host has activated the alternate clip recorder, the host proceeds to block 976 and combines the temp files into one clip file. The host stores the clip file in memory. The host next proceeds to decision block 977 to determine if archive recording is complete.

If archive recording is not yet complete, the host proceeds back to block 972 to await activation upon the alternate clip recorder reaching the next segment boundary. If clip recording is complete, the host proceeds from decision block 977 to block 978 and stops the process.

Thus, the host can capture video and audio and store the captured images into one or more clip files that can be retrieved and communicated to users in the same manner that currently captured images are communicated to users.

FIG. 9C is a representation of a format of a stored clip. A clip file can be composed of, for example, a clip file header 991, a clip file segment table 992 and one or more clip file segments. The clip file segments can be video, audio, information that can include stream information and motion information, video key frames and audio key frames.

A clip file header includes a two clip ID values, 991a-b that are used to identify the clip as a clip used in the particular image capture system. The file version 991c identifies the version of the clip file format. A user of an updated version may need to identify a particular version number in order to support the clip file. Additionally, older versions of a clip viewer may not have the ability to support newer versions of clips and the version information may allow the viewer to identify clips that are not supported. For example, a viewer may by default not support versions newer than the versions that existed at the time of its release.

The “Num Segments” field identifies the number of segments in the file. The “Size Seg Info” field identifies the size of each segment information block in the segment table 992.

The segment table 992 includes one or more segment info blocks 992a-992n. Each segment info block includes a segment type field that identifies the major data type, which can be, for example, video, audio, or information. A “Seg Subtype” field identifies a subtype within the identified type. A subtype can be, for example, video encoding or audio quality. An “Offset” field identifies an offset in bytes of the segment from the beginning of the file. “Size” identifies the size of the segment in bytes. “Frames” identifies the number of frames in that segment, where appropriate.

Stream information includes a number of fields identifying information relating to the stored clip. “Header Size” identifies the size of this structure. “Title Offset” and “Title Size” identify the offset relative to this header and length in bytes of the clip title. “Clip Length” values identify the duration of the clip in seconds and milliseconds.

A motion level table includes fields that identify information relating to the level of motion in the clip. “Num Entries” identifies the number of entries in the segment. “Motion Level” values can be, for example, 0-4095 where higher numbers indicate more motion. A video key frames table includes a number of video key frame fields 996. Each of the key frames includes information relating to a particular key frame in the clip. “Frame Number” 997a identifies the image number of the frame in the video segment. “Frame Times” 997b identify the times at which the frame was recorded. “Offset” 997d identifies the offset in bytes of this frame relative to the beginning of the video segment.

Similarly, an audio key frame table includes a number of audio key frame fields 998. Frame Number” 999a identifies the image number of the frame in the audio segment. “Frame Time” 999b identifies the time at which the frame was recorded. “Offset” 999c identifies the offset in bytes of this frame relative to the beginning of the audio segment.

A process for conserving network bandwidth by transmitting only changed image blocks is performed by the video CGI 52a (see FIG. 1C) and is shown in FIG. 10. The process begins by capturing an image (step 1010). The process then performs block motion detection 800 as described above with reference to FIG. 8. Additionally, at step 1020, the oldest blocks in the image, those unchanged after a predetermined number of image capture cycles, are marked as having changed even though they may remain the same. Marking the oldest blocks as having changed allows the image at the client to be refreshed over a period of time even though there may be no new information in the image frame. At step 1030, the route the process takes diverges depending on a chosen compression level. The host may preselect the level of compression. Alternatively, the host may offer the client a choice of compression levels. If low compression is selected, the process continues to step 1040, and the image to be transmitted to the client is set to the full image frame. The process then constructs the appropriate header (step 1042) and creates the JPEG image for the full image frame (step 1044). The process then proceeds to step 1090.

When medium compression is selected at step 1030, the process first finds the minimum region containing changed blocks (step 1050). The fraction of changed blocks in the minimum region is compared to a predetermined threshold at step 1052. If the fraction exceeds the predetermined threshold, the process constructs a header (step 1042), creates a JPEG image (step 1044), and proceeds to step 1090. On the other hand, if the fraction is less than the predetermined threshold at step 1052, the process continues to step 1060.

If high compression is selected at step 1030, the process continues to step 1060. At step 1060, the process constructs a header and stripe image for the changed blocks and the oldest unchanged blocks and proceeds to step 1065. At step 1065, the process creates a JPEG blocks for the stripe image and proceeds to step 1090. At step 1090, the data is transmitted to the client.

FIG. 11 is a block diagram of one format of an audio stream. The audio stream comprises a series of audio frames 1110 that are transmitted by the host in encoded form to the client. The encoding of an audio frame is described below with reference to FIG. 12. Additionally, the host also compresses the audio data to reduce the required bandwidth for transmission. Each audio frame 1110 has a header 1120 followed by eight blocks 1121-1128 of encoded audio data.

The header 1120 of each audio frame 1110 comprises five fields. The first is a host time field 1130. This four-byte field indicates the host clock time corresponding to the audio frame. The host time field 1130 allows the client to, for example, match the audio frame to the corresponding video frame. The second field in the frame header 1120 is a one-byte bit depth field 1132. The bit depth field 1132 is followed by a two-byte frame size field 1134. The frame size field 1134 communicates the length of the audio frame to the client. The last two fields in the frame header 1120 contain decoder variables that correspond to the method used to encode the audio frames. These fields include a two-byte LD field 1136 and a one-byte SD field 1138. The LD and SD fields 1136, 1138 are algorithm specific variables used with the 2-bit and 4-bit ADPCM audio encoders discussed above with reference to FIG. 5A.

Each block 1121-1128 in the audio frame 1110 contains a silence map 1140 and up to eight packets 1141-1148 of audio data. The silence map 1140 is a one-byte field. Each of eight silence bits in the silence map field 1140 corresponds to a packet of encoded audio data. The information in the silence bits indicates whether or not the corresponding packet exists in that block 1121-1128 of the audio frame 1110. For example, the silence map field 1140 may contain the following eight silence bits: 01010101, where 1 indicates a silent packet. This silence map field 1140 will be followed by only four packets of encoded audio data corresponding to silence map bits 1, 3, 5 and 7. If the corresponding packet does not exist (e.g., those corresponding to silence map bits 2, 4, 6 and 8 in the above example), the client will insert a silence packet with no audio data in its place. Thus, only packets with non-silent data must be transmitted, thereby reducing the required bandwidth. Each packet that is transmitted after the silence map 1140 consists of 32 samples of audio data.

FIG. 12 is a flow chart illustrating the encoding and generation of the audio frame for transmission to the client. The encoding begins at step 1210 with the capture of 2048 audio samples from an audio source such as a microphone, CD player or other known sources. The samples are then digitized in packets of 32 samples each and groups the packets into blocks, each block containing eight packets (step 1215). A group of eight blocks then forms a frame. At step 1220, the audio CGI 52b (see FIG. 1C) determines whether the current packet is silent. If the packet is silent, at step 1230, the silence bit in the silence map corresponding to the packet is set to 1. The data in the packet is not encoded, and the process continues to step 1260. If, on the other hand, the packet is not silent, the corresponding silence bit is set to 0 (step 1240), and the data in the packet is encoded (step 1250). The process then continues to step 1260.

After each packet is processed, the process determines whether the processed packet was the eighth and last packet of its block of data (step 1260). If the packet was not the last of its block, the process returns to step 1220 and processes the next packet of 32 samples. If the packet was the last of its block, the process writes the silence map and any non-silent packets into the block and proceeds to step 1270.

At step 1270, the process determines whether the preceding block was the eighth and last block of the audio frame. If the block was not the last of the frame, the process returns to step 1220 to begin processing the next block by processing the next packet of 32 samples. If the block was the last of the audio frame, the process writes the audio frame by writing the header and the eight blocks. At step 1280, the audio frame is transmitted to the client.

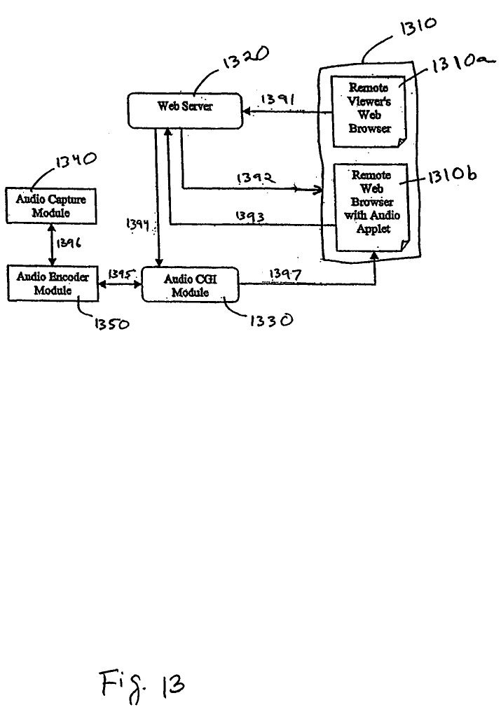

FIG. 13 is a block diagram illustrating the broadcast of the audio data by the host to clients and the flow of commands and information between components of the host and the client. The audio broadcast begins when the client, via the remote user's web browser 1310a, sends a request (indicated by line 1391) to the host server system 1320. In one embodiment, the request is an HTTP request. In response to the request, the server system 1320 sends (line 1392) a Jar to the client's web browser 1310. The Jar includes an applet that is launched by the client's web browser. Although FIG. 13 indicates the web browser 1310 as having two blocks 1310a, 1310b, it is understood that the two blocks 1310a, 1310b only illustrate the same browser before and after the launching of the applet, respectively. Among other functions, the applet then sends a request to the web server 1320 for the web server 1320 to launch a CGI (line 1393). Additionally, the applet causes the client to send client-specific parameters to the web server 1320. In response to the request, the web server 1320 establishes a socket and launches a CGI 1330 according to the parameters supplied by the client and information associated with the socket (line 1394). The CGI 1330 submits periodic requests for audio sample information to an audio encoder 1350 (line 1395). The audio encoder 1350 receives audio samples from an audio capture module 1340 and encodes the samples as described, for example, above with reference to FIG. 12 (line 1396). The encoder 1350 responds to the periodic requests from the CGI 1330 by making the encoded audio information available to the CGI 1330 via, for example, shared memory (line 1395). The audio encoder module 1350 audio CGI module 1330 may be sub-modules in the audio CGI 52b shown in FIG. 1C. The CGI 1330 transmits the encoded audio frames to the applet over the established socket (line 1397). The applet decodes the encoded audio frames, providing audio to the user.

FIG. 14 is a flow chart of the function of the dynamic domain name system (DNS) updating process performed by the IP PROC module 60 illustrated in FIG. 1C. The updating process begins when the host 10 (see FIGS. 1A-C) connects to a network 20 such as the Internet. When the host 10 connects to the network 20, it may be assigned a different Internet Protocol (IP) address from that which it was assigned during a previous connection. For example, the host 10 may connect to the Internet 20 through a service provider. The updating process, therefore, first checks to determine whether the current IP address is new (step 1410). If the IP address is unchanged, the process continues to step 1450. On the other hand, if the IP address is new, at step 1420, the process sends a request to a DNS host server 90 to update the IP address. The DNS host server 90 updates the IP address corresponding to the requesting host in its database or in a DNS interface 92 of service provider affiliated with the host 10 (step 1440). In response to the request, the process receives an update from the DNS host server 90 at step 1430. The process then proceeds to step 1450. The process is repeated at regular intervals, such as every 2 minutes, to keep the IP address in the DNS host server 90 updated. When a client 30 seeks to obtain data from a host 10, the client 30 is directed to the DNS host server 90 which uses the updated information to direct the client 30 to the proper host 10.

In a further embodiment, the host 10 may specify a schedule to the DNS host server 90. The schedule may indicate when the host 10 is connected to the network 20 and is available to clients 30. If the host 10 is not available, the DNS host server 90 can direct a client 30 to a web page providing the schedule and availability of the host 10 or other information. Alternatively, the DNS host server 90 can monitor when the host 10 is not connected to the network 20. When the host 10 is not connected to the network 20, the DNS host server 90 can direct a client 30 to a web page with an appropriate message or information.

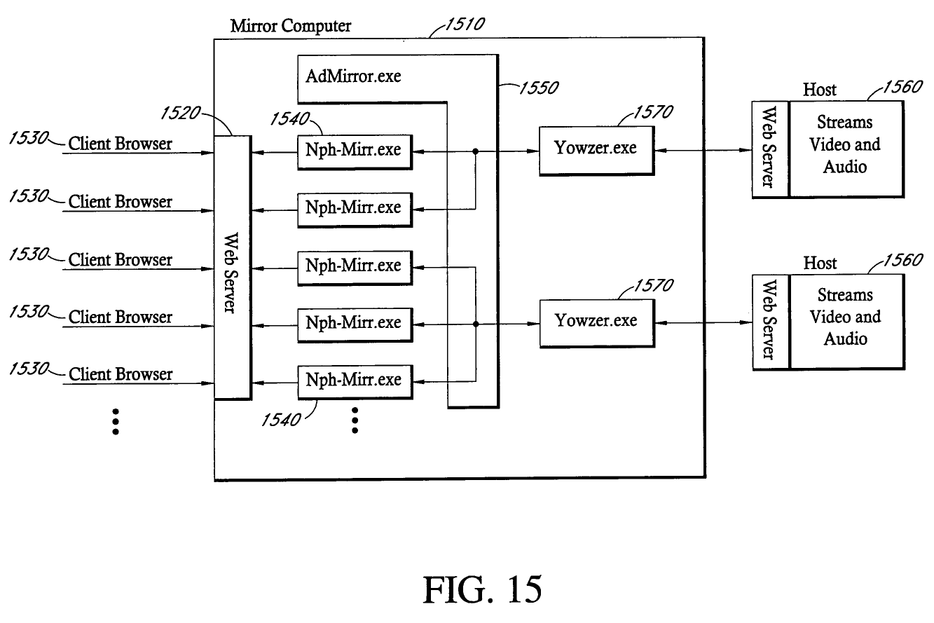

FIG. 15 is a block diagram of a system for mirroring audio and video data streamed by the host. A mirror computer 1510 is configured with a web server process 1520 to interface with clients 1530. In response to requests from clients 1530 made to the web server process 1520, the mirror computer 1510 launches a CGI process, nph-mirr 1540, for each requesting client 1530. An AdMirror process 1550 running on the mirror computer 1510 coordinates the mirroring of one or more host 1560. When a client 1530 makes a request to the web server 1520 for a specific host 1560, the nph-mirr process 1540 corresponding to that client 1530 causes the AdMirror process 1550 to launch a Yowzer process 1570 for the specific host 1560 requested by the client 1530. The Yowzer process 1570 coordinates the connection of the mirror computer 1510 to the host 1560 and the streaming of the video and audio data from the host 1560. If a Yowzer process 1570 already exists for the specific host 1560, as may happen if the specific host 1560 has been previously requested by another client 1530, an additional Yowzer process 1570 is not launched. The AdMirror process 1550 then causes the Yowzer process 1570 corresponding to the requested host 1560 to interface with the nph-mirr process 1540 corresponding to the requesting client 1530. Thus, a single Yowzer process 1570 may support multiple nph-mirr 1540 processes and their corresponding clients 1530.

Each nph-mirr process 1540 functions as, for example, the CGI 52 described above with reference to FIG. 1C, and coordinates streaming of data from the host 1560 to the client 1530. Accordingly, the nph-mirr process 1540 sends an applet to the client 1530 and receives parameters related to the capabilities of the client 1530 and client's browser. Thus, the client 1530 receives streamed data at, for example, a frame rate that corresponds to its capability to process the frames.

Thus, while the host 1550 streams data to the mirror computer 1510, the mirror computer 1510 assumes the responsibility of streaming the data to each of the clients 1530. This frees the host 1550 to use its processing power for maintaining high video and audio stream rates. The mirror computer 1510 may be a dedicated, powerful processor capable of accommodating numerous clients 1530 and numerous hosts 1550.

The figures and associated text have shown how a host can be coupled to multiple cameras and have shown how captured images can be archived, distributed, or used for motion detection. Additionally, compression formats and distribution techniques implemented by a host have also been disclosed. Although the figures and text have focused primarily on the function of a host and a single image capture device, the system is not limited to operating with a single camera. The compression, archival, motion detection, and distribution techniques apply equally to multiple camera configurations. In fact, the host may be connected to more cameras than can be supported in a single communication link.

A user can, for example, interface with the web server (50 in FIG. 1C) to a control module, for example 290, to configure a choice of cameras, the selected view, and the functionality desired. For example, a first user may select to view four cameras from a list of available cameras and may configure the host to perform motion detection based on the captured images from the four cameras.

The compressed archive format allows the host to provide clients a great deal of information regarding archive files and their contents and a great deal of control over the playback and display of the archived clip files. For example, the host 10, through control module 290, can provide an estimate of the disk or memory consumption for a particular archive configuration. For example, a user may configure the host 10, through the control module 290, to archive the captured images from a camera over a predetermined time, say 24 hours. Because the control module 290 in the host 10 can identify the camera resolution and frame rate, the control module can estimate disk consumption for the archive file. The control module 290 can communicate the estimate to the client for display to the user. Similarly, the control module 290 can estimate disk consumption for motion detection archives. The control module 290 can estimate disk consumption for each motion detection event, but typically cannot predict a total archive size because the host has no knowledge of the number of motion detection events that will occur.

The control module can also control playback of the archived clip files and can display information regarding the clip file to a client. The control module can be configured to allow playback of an archive file using an interface that is similar to that of a video recorder. The control module can accept client commands to play a video clip, fast forward the clip, rewind the clip, pause the clip and also jump forward or backward in the video clip archive.

The control module provides the video clip to the client in response to the play command. The control module can provide frames at an increased rate or can provide a subset of frames in response to a fast forward command. Because the compression technique used for the clip file can use a format that builds frames based on the content of previous frames, the format may not be conducive to fast rewind. However, because key frames may occur periodically in the clip file, the control module can step back through the key frames in response to a rewind command.

The control module can also jump to any part of the clip file. The control module can, for example display a bar, line, meter or other feature, that represents the time line of the video clip. The control module can accept client commands to jump to any position on the time line. The control module can, for example locate the nearest key frame that approximates the requested position in the clip file and resume playing from that point. Additionally, the control module may accept commands to perform relative jumps in time through the clip file. The control module, using the frame numbering stored in the clip file, can estimate the nearest key frame corresponding to the relative jump and resume playing from that frame.

In addition, the control module can access the motion levels associated with the clip file and display an indication of motion or activity. Such an indication can be, for example, a motion index or an activity line. The user at the client can then examine the motion index or activity line to determine what portions of the clip file contain the most activity.

A second user can also connect to the same host, web server, and control module used by the first user and can select to view multiple cameras that are the same, different, or overlap the cameras selected by the first user. The second user may also configure the host to perform entirely different functions on the captured images. For example, the second user can configure the host to continuously record the captured images from the desired cameras and archive the images in 24 hour increments. Additionally, the second user may configure the host to allow the archived images to expire after a predetermined period of time, such as one week. Thus, there are numerous ways in which different user may configure the same host. Each user can control the output of the host independently of any other user. One or more users can be provided control over the cameras, such as pan, tilt, and zoom (PTZ) control over the cameras. Such a user may affect the images captured by the cameras and thus, may affect the images seen by other users.

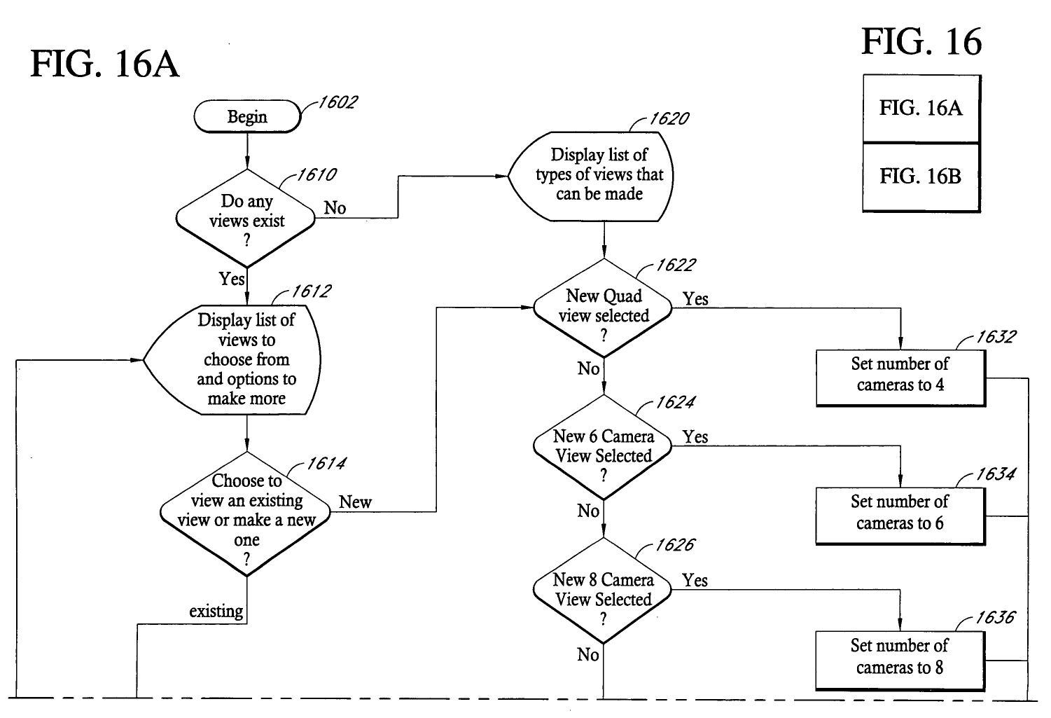

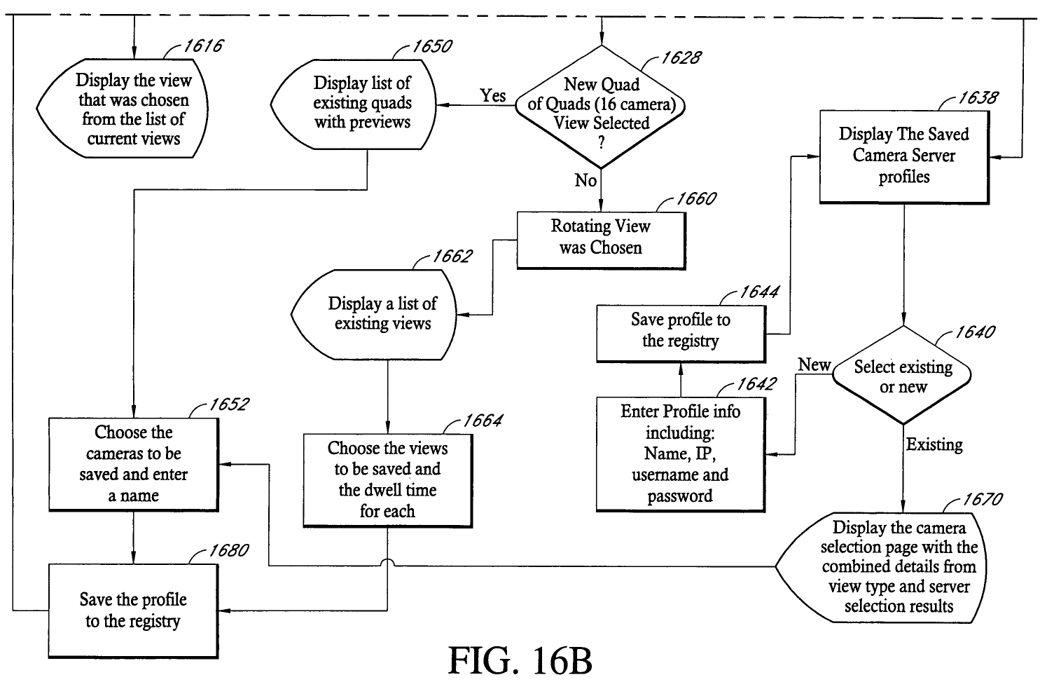

FIG. 16 is a flow chart of a user configuration process that can be implemented by the host. The control module 290 can perform the user configuration process in response to user commands. The host can be configured by a remote user, for example, using a network connection to the web server at the host.

The process begins at block 1602 when, for example, a user connects to the control module through the host web server and requests configuration or display of one or more camera views. The host proceeds to decision block 1610 and determines if any camera views already exist. That is, the host determines if previously a user has designated and stored a camera configuration that is accessible by the current user.

If no views currently exist, the host proceeds to block 1620 where the host displays the list of typed of views that can be configured by the user. For example, the host may be configured to provide to the user camera views in one of a predetermined number of formats. The process shown in the flow chart of FIG. 16 is configured to allow the user to select from a quad view, a six camera view, an eight camera view, a sixteen camera view, or a rotating view. Of course a host may be configured to provide other views, fewer views, or additional views.

The host can display a list of types of views that can be made by, for example, communicating a web page from the host web server to a client browser that shows the types of views. Alternatively, the host can display a list of types of views by controlling a local display. Throughout the process, the act of the host displaying an image can refer to a local display of the image or a remote display of an image at a browser connected to the web server.

The host then proceeds to decision block 1622 to await a user selection and to determine if the user selection is a quad view. A quad view is a view of four cameras in which each of the camera views occupies one quadrant of the display. If the host determines that the user has not selected a quad view, the host proceeds to decision block 1624 to determine if the user has selected a six camera view.

If the user has not selected a six camera view, the host proceeds to decision block 1626 to determine if an eight camera view has been selected by the user. If the user has not selected an eight camera view, the host proceeds to decision block 1628 to determine if a sixteen camera view has been selected by the user. If the user has not selected a sixteen camera view, the host proceeds to block 1660 and defaults to the only remaining view available, the rotating view.

The rotating view allows a user to rotate the display view among a predetermined number of selected views. Each of the views selected by the user is displayed for a predetermined period of time. The user selects a number of custom views, which are swapped according to a predetermined sequence. The host proceeds from block 1660 to block 1662 to display a list of views that can be selected for the rotating view. The list of views can be a list of existing views or can be a list of cameras from which views can be created. Again, the host web server communicating over a network connection can control the display on a client browser.

The host proceeds from block 1662 to block 1664 to receive the user selection of views to be saved and a dwell time for each view. The host next proceeds to block 1680 where the information is saved as a user profile in a registry. The user defined view then remains the view for that user until the user reconfigures the view.

Returning to decision block 1622, if the user selects a quad view, the host proceeds to block 1632 and the configuration is set to four cameras. The user can be prompted to choose the four cameras from an available set of cameras and can select the display position of the cameras in the quad view. Once the user provides this information, the host proceeds to block 1638.

Returning to decision block 1624, if the user selects a six camera view, the host proceeds to block 1634 and the configuration is set to six cameras. The user can be prompted to choose the six cameras from an available set of cameras and can select the display position of the cameras in the six camera view. The positions of the cameras can be chosen from a predetermined view, such as a two column view having three rows. Once the user provides this information, the host proceeds to block 1638.

Returning to decision block 1626, if the user selects an eight camera view, the host proceeds to block 1636 and the configuration is set to eight cameras. The user can be prompted to choose the eight cameras from an available set of cameras and can select the display position of the cameras in the eight camera view. The positions of the cameras can be chosen from a predetermined view, such as a two column view having four rows. Once the user provides this information, the host proceeds to block 1638.

At block 1638, the host displays saved camera server profiles. The host then proceeds to decision block 1640 to determine if the user selects has selected an existing server profile or if the user desires to create a new profile. If the host determines that the user requests to make a new profile, the host proceeds to block 1642.

In block 1642, the host requests and receives the new profile information, including a name of the profile, an IP address, a username and a password. The host then proceeds to block 1644 and stores the newly created profile in memory. The host then returns to block 1638 to display all of the existing camera server profiles, including the newly created profile.

Returning to block 1640, if the host determines that the user has selected an existing profile from the list, the host proceeds to block 1670. In block 1670, the host displays the camera selection page with the combined details from the view type and the server selection results.

The host then proceeds to block 1652 where the host receives the user selection for cameras. The host saves the camera selection and receives a name for the profile. The host then proceeds to block 1680 where the profile is saved to the registry.

Returning to decision block 1628, if the host determines that the user has selected a view of a quad of quads, the host proceeds to block 1650. The quad of quads view display sixteen camera images simultaneously and can be configured as a simultaneous view of four different quad views.

At block 1650, the host displays a selection of existing quad views that can be selected by the user. The host may also display previews of the images associated with each of the quad views. The host then proceeds to block 1652 to receive the user selection of cameras. The host saves the camera selection and receives a name for the profile. The host then proceeds to block 1680 where the profile is saved to the registry.

Returning to decision block 1610, if the host determines that existing views are saved, the host proceeds to block 1612 where the host displays the list of views to choose from. The host can also include an option to create a new view.

The host proceeds to block 1614 to determine if the user has selected an existing view or if the user has selected to create a new view. If the user has selected to create a new view, the host proceeds to decision block 1622 and proceeds in much the same manner as in the case where no existing views are saved.

Returning to decision block 1614, if the host determines the user has selected an existing view, the host proceeds to block 1616 to display the view that was chosen from the list of current views. The view process is then finished and displays the view to the user until the user requests a different view.

The multiple camera view configuration detailed in FIG. 16 is extremely useful when multiple camera views are configured by a remote viewer using a web browser. However, some users may not prefer windowed camera views but may instead prefer one or more camera images appearing on a full screen display. Such a display structure may be preferred for real time or live viewing of captured camera images, such as in a live security camera surveillance configuration. The host can be directed, through the user interface, to automatically configure multiple cameras in a full screen view configuration.

For example, a security surveillance system may include 16 cameras as external capture devices connected to one host. The host, in response to user selection, may generate full screen displays that are populated with the images captured by the cameras. The full screen views can show a single camera view, a 2×2, 3×3, 4×4 or some other camera view configuration. Where more cameras capture images than are shown in one full screen view, the full screen view can rotate among available camera views, periodically showing the images captured from each of the cameras. In one configuration, the host automatically defaults to a full screen view configuration based on the number of cameras configured with the host.

Although the screen view is a full screen image, rather than a windowed image, the features available through the host are still available. For example, motion detection can be set up on each of the camera images and alarms can be triggered based on the captured images. Because nearly the entire screen is dedicated to the camera images, the display can indicate alarms and alerts by highlighting the image associated with the alarm. For example, an image generating a motion alarm can be outlined with a red border.

Additionally, the host provides a status bar in one portion of the screen that includes such features as alarm indications, and command options, such as snap recording options. Other command features can include recording playback commands that allow operators to view previously recorded images. A video card used by the computer to drive the monitor may have a monitor outputs that can be routed to video recording equipment or auxiliary monitors to allow the monitor display to be recorded or viewed at another location.

As discussed above in relation to FIGS. 9A-9C, an archive module can generate clip files in response to a triggering event, such as motion detection, or a time schedule. In one example, cameras are configured to continually capture images and the archive module create archive files for images captured by each camera. The archive files can cover various time periods such as 24 hour. Such a configuration can be implemented, for example, when the cameras and system are configured as a security surveillance system. In such a system, there may be no prior knowledge of a motion detection event that is to be used to trigger file archival, thus archiving is performed continuously. However, events may be discovered after the fact and the archived files may need to be analyzed for information. For example, surveillance cameras imaging a parking lot may normally be expected to capture significant motion. However, a particular event, such as a vehicle theft, may occur in the parking lot requiring review of archived files. In such a situation, it is advantageous to be able to quickly search the archived files for motion activity adjacent to the vehicle of interest.

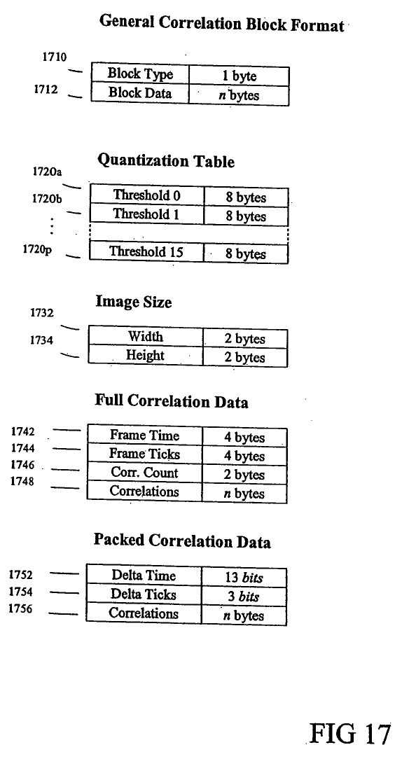

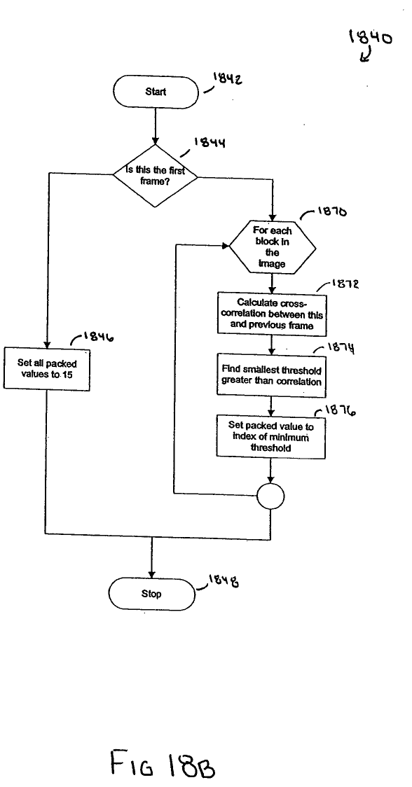

FIG. 17 is a representation of one embodiment of a format of correlation data that can be included with a stored clip. The correlation data blocks detailed in FIG. 17 can be stored in the clip file along with the image data. The correlation data can then be searched to identify motion that is captured within the file. The search process is described in further detail in relation to FIG. 19.

The general format of a correlation block includes a block type field 1710 that identifies the type of data that follows. Valid block types include Quantization Table, Image Size, Full Correlation Data, and Packed Correlation Data, for example. Each of these block types is described in further detail below. The block type field 1710 is one byte in length.

The correlation block also includes a block data field 1712 that contains the appropriate data for the block type identified in the block type field 1710. The length of the block data filed varies depending on the block type. However, because the length of the block data field can be determined based on the block type and previous correlation information, such as image size, it is not necessary to include a field that records a size of the data block.

A Quantization Table represents one type of correlation data block type. The correlation values can be determined on portions of each frame relative to a previously captured frame. One application of the correlation value was previously described in relation to the motion detection process detailed in FIG. 8. As was previously described in relation to FIG. 8, a captured image can be divided into a number of sub-blocks. The sub-blocks can be, for example, 16×16 pixels in size, or some other block size. Because not all captured images may be evenly divided into 16×16 blocks, some blocks may actually be smaller than 16×16. Such would be the case for any correlation block size.

A sub-block is compared to a corresponding sub-block in a previously captured frame to determine the correlation. Correlation values can be determined, for example, for each captured video frame. The correlation values can vary from −1 to +1 and can be determined as double-precision floating point values. Storing correlation values in double-precision floating point format uses a large amount of storage space. To minimize the storage space required to store the correlation values, the double-precision floating point values are quantized to sixteen values so that they can be represented by a four bit number. The four bit correlation value is referred to as the ‘quantized’ correlation value. The Quantization Table consists of the 16 double-precision floating point fields 1720a-1720p representing each of the 16 quantization values. The threshold values are arranged in order from lowest correlation to highest correlation. Threshold 0 represents the lowest correlation value and Threshold 15 represents the highest correlation value. The quantization values can be linearly spaced or can be spaced geometrically, spaced according to a compression curve, or spaced in a random or pseudo-random manner. Thus, a quantized four bit correlation value having a value of ‘3’ can be converted, using the Quantization Table, to the double-precision floating point value stored in the location identified by Threshold 3.

An Image Size represents another type of correlation data block type. The Image Size type includes two data fields. A width data field 1732 stores the width of the captured image and a height data field 1734 stores the height of the captured image. The width and height numbers, for example, can represent the number of pixels. The image size is used, in part, to determine the number of correlation blocks in the image.

Full Correlation Data represents another correlation data block type. The Full Correlation Data includes a Frame Time field 1742 that identifies the timestamp of the frame associated with the correlation values. The frame time can represent, for example, seconds from the start of the clip file. A Frame Ticks field 1744 is also used to record the timestamp of the frame. The Frame Ticks field 1744 can represent, for example, the time in milliseconds after the Frame Time. A Correlation Count field 1746 records the number of correlation values in the frame. The Correlations fields 1748 record the quantized correlation values.

Packed Correlation Data represents still another correlation data block type. The Packed Correlation Data includes Delta Time 1752 and Delta Ticks 1754 fields. Delta Time 1752 represents the time difference, in seconds, between the previous timestamp and the current timestamp. Similarly, Delta Ticks 1754 represents the time difference, in milliseconds, between the previous timestamp and the current timestamp, minus the Delta Time value. The Correlations field 1756 includes the quantized correlations for each of the correlation blocks in the frame.

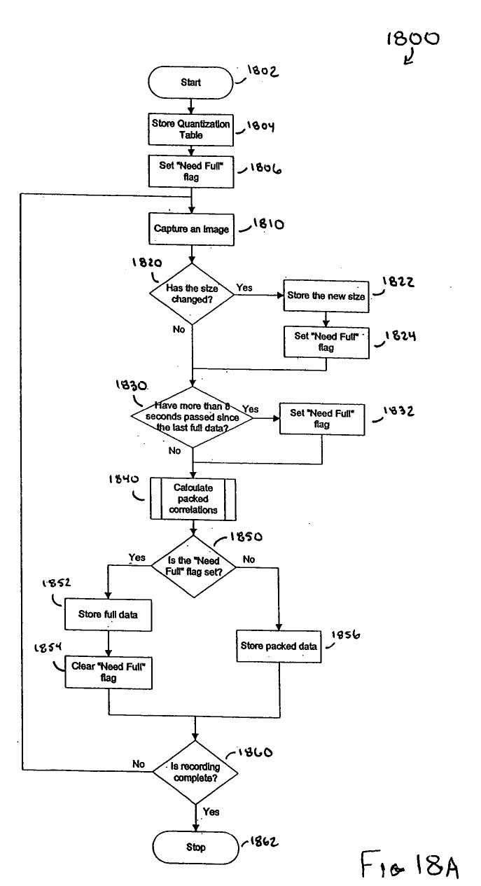

The process 1800 of generating and storing the correlation values is shown in the flowchart of FIG. 18A. The process 1800 begins at block 1802, such as when it is called by the archive module 56 of FIG. 1C. The archive module 56 can run the process 1800 using the processor 302 and memory 304 of a personal computer 300. The archive module can initiate the process 1800, for example, upon creation of a new clip file.

The archive module proceeds to block 1804 where a quantization table having predetermined quantization values is stored in the clip file. The archive module then proceeds to block 1806 to set a ‘Need Full’ flag to indicate that a full correlation data set needs to be recorded.

The archive module then enters a loop in the process 1800 that is performed for each frame in the image file. At block 1810 the archive module captures an image, such as an image in the image pool captured by an external video camera.

The archive module then proceeds to decision block 1820 to determine if the image size has changed. If the image size has changed, the number of correlation blocks will likely change and the position of a correlation block in the new image size may not correspond to an image in the prior image size.

If the image size has changed, the archive module proceeds to block 1822 to store the new image size in an Image Size data block. The archive module then proceeds to block 1824 to set the “Need Full” flag to indicate that a full correlation data set needs to be recorded. The archive module then proceeds to decision block 1830.

Returning to decision block 1820, if no change in the image size is determined, the archive module proceeds directly to decision block 1830. At decision block 1830, the archive module determines if a predetermined period of time has elapsed since the last full correlation data has been recorded. FIG. 18A shows the predetermined period of time to be 8 seconds. However, the predetermined period of time may be any value and need not be expressed in increments of time but instead, may be expressed in number of frames. If the predetermined period of time has elapsed since the last recordation of a full correlation data set, the archive module proceeds to block 1832 where the “Need Full” flag is set. The archive module then proceeds to block 1840.

Returning to decision block 1830, if the predetermined period of time has not elapsed, the archive module need not set the “Need Full” flag, although the module may have set the flag for other reasons. The archive module then proceeds to block 1840.

At block 1840, the archive module determines the quantized correlation values. This block is further detailed in the flowchart of FIG. 18B. After determining the quantized correlation values, the archive module proceeds to decision block 1850 to determine if a full correlation data set or a packed correlation data set is to be recorded.

In decision block 1850, the archive module determines if the “Need Full” flag is set. If the flag is set, the archive module proceeds to block 1852 where a full correlation data set is stored. From block 1852, the archive module proceeds to block 1854 and clears the “Need Full” flag. From block 1854, the archive module proceeds to decision block 1860.

Returning to decision block 1850, if the “Need Full” flag is not set, the archive module proceeds to block 1856 and store the packed correlation data set in the clip file. The archive module next proceeds to decision block 1860.

In decision block 1860, the archive module determines if recording is complete, for example, by determining if a clip file boundary is reached. If recording is not yet complete, the archive module returns to the beginning of the loop at block 1810 to again capture another image. If recording is complete, the correlation generating process 1800 is also complete. The archive process proceeds to block 1862 where the process 1800 is stopped. FIG. 1 8B is a flowchart of the process 1840 for determining quantized correlation values. The archive module determines the quantized correlation values as part of the correlation value generation and recording process shown in FIG. 18A. The process 1840 can be run by the archive module or any other module that requires quantized correlation values.

The archive module enters the quantized correlation process 1840 at block 1842. From block 1842 the archive module proceeds to a loop beginning at decision block 1844. At decision block 1844, the archive module determines if the frame being examined is the first frame in the clip file. If so, there may not be any prior frames for which a correlation value can be determined. If the archive module determines the frame is the first captured frame in the file, the archive module proceeds to block 1846 where all packed correlation values are set to 15, representing the highest level of correlation. The process 1840 is then finished and the archive module exits the process by proceeding to the end at block 1848.

Returning to decision block 1844, if the archive module determines that the captured frame is not the first frame in the file, the archive module proceeds to block 1870, representing the entry of another loop performed for each correlation block in the image.

From block 1870 the archive module proceeds to block 1872 where the cross-correlation between the current block and the corresponding block in the previous frame is determined, for example, using the process described in connection with FIG. 8. As noted earlier, this correlation value can be determined as a double-precision floating point value.

From block 1872, the archive module proceeds to block 1874 where the archive module compares the determined correlation value against the values stored in the quantization table to determine the smallest threshold that is greater than the correlation value. That is, the archive module determines where in the quantization table the correlation value falls.

The archive module next proceeds to block 1876 and sets the quantized correlation value to the four bit index value of the threshold determined in block 1874. The archive module then returns to block 1870 if each correlation block has not yet been determined. Alternatively, if all correlation blocks have been analyzed, the archive module proceeds to block 1848 and the process 1840 is complete.

FIG. 19 is a flowchart of a process 1900 of searching a stored file for motion based in part on correlation values. The process 1900 can be run by the motion detector module 242 of FIG. 2C using the processor 302 and memory 304 of the computer 300 of FIG. 3A. In other embodiments, the process 1900 can be run by the main module of FIG. 1C, the control module 290 of FIG. 2C, or some other module, such as a search module. The file that is analyzed can be, for example, stored in any of the storage devices or nodes shown in FIG. 3B.

The motion detector begins at block 1902 when the process 1900 is called. The motion detection process 1900 can operate on a single file or can be configured to operate on files captured over a desired period of time. At block 1902, the motion detector sets all counters and settings to their default values. From block 1902, the motion detector proceeds to block 1904 where a region of interest is defined. In one example, the motion detector retrieves the first frame in the file of interest and displays the single frame in a display, such as monitor 314 of FIG. 3A. A user can then use an input device, such as mouse 312 to indicate a region of interest in the image. The motion detector module may allow a user to define a region of interest by circling it with the mouse cursor. Other means for defining a region of interest can include defining a box using an input device, highlighting a region of interest from a predetermined image grid, or some other means for identifying a region of interest.

For example, returning to the parking lot surveillance archive described above, the region of interest may only be the area immediately surrounding a particular car or space in a parking lot. A user analyzing the archive file may not be interested in all of the motion occurring in other parts of the parking lot. A user can view the first image in the parking lot archive file and use the mouse to circle an area surrounding the parking space, thereby defining a region of interest.

The defined region of interest can encompass one or more correlation blocks. If the region of interest encompasses at least one half of the area defined by a correlation block, the motion detector includes the correlation block in the analysis. The motion detector proceeds to block 1910.

The correlation blocks can be resized to correlate with the image viewing size. For example, the user can draws an arbitrary mask shape on the sample image at 400×300 pixels. The video to be searched may have been recorded at 320×240 pixels, which means that the correlation structure contains 20×15 blocks. Each correlation block is represented by 20×20 pixels in the mask. For each of these 20×20 regions, if more than 50% of the pixels in the mask are marked as “to be tested,” then that correlation block will be tested.

At block 1910 the motion detector reads the first correlation data chunk associated with the archive file. The motion detector then proceeds to decision block 1920. At decision block 1920, the motion detector determines if the data chunk represents an image size data block. If so, the motion detector proceeds to block 1922 to scale the defined region of interest mask to the image size defined by the image size data block. The motion detector then returns to block 1910 to read the next correlation data block.

Returning to decision block 1920, if the motion detector determines that the data block does not correspond to an image size block, the motion detector proceeds to decision block 1930 to determine if the data block corresponds to a quantization data block.

If the motion detector determines that the data block corresponds to a quantization table, the motion detector proceeds to block 1932 and loads the new quantization table from the data block. The motion detector then returns to block 1910 to read the next correlation data block from the archive file.

Returning to decision block 1930, if the motion detector determines that the data block does not represent a quantization table, the motion detector enters a loop beginning at block 1940 that is performed for each correlation block in the defined region of interest.

The motion detector proceeds to block 1942 and unpacks the quantized correlation value by comparing the quantized correlation value to the values in the quantization table. As noted earlier, each quantized correlation value can be converted back to a double-precision floating point correlation value using the quantization table.

The motion detector then proceeds to decision block 1950 to determine if the correlation value is below a predetermined threshold. The correlation threshold can be a fixed value, or can be user defined by selecting from a number of correlation values. User selection of correlation values can be input to the motion detector through a keypad, dial or slide bar. The user need not be provided actual correlation values to choose from but instead, can be allowed to enter a number or position a slide bar or dial in a position relative to a full scale value or position. The relative user entry can then be converted to a correlation threshold. If in decision block 1950, the motion detector determines that the correlation value is below the correlation threshold, the motion detector proceeds to block 1952 and a changed block count value is incremented. From block 1952, the motion detector returns to block 1942 until all correlation blocks in the region of interest have been compared to the threshold. Once all correlation blocks have been analyzed, the motion detector proceeds from block 1952 to decision block 1960.

Returning to decision block 1950, if the correlation value is above the correlation threshold, the motion detector returns to block 1942 until all correlation blocks in the region of interest have been compared to the threshold. If all correlation blocks have been analyzed, the motion detector proceeds from decision block 1950 to decision block 1960.

At decision block 1960, the motion detector determines if the changed block count is above a predetermined motion threshold. Again, the motion detector can use a fixed value or a user defined value. The user defined value can be input to the motion detector in much the same manner as the correlation threshold.

If the changed block count exceeds the motion threshold, the motion detector proceeds to block 1962 and records the frame as having motion. The motion detector proceeds from block 1962 to decision block 1970. Alternatively, if the changed block count is not above the threshold, the motion detector proceeds from decision block 1960 to decision block 1970.

At decision block 1970, the motion detector determines if the file is complete. If the last frame in the file has not been analyzed, the motion detector returns to block 1910 to read the next correlation data block.

If, at decision block 1970, the last frame has been analyzed, the motion detector proceeds to block 1972 and reports the number of frames with motion. For example, the motion detector can compile a list of frames where motion was initially detected and a time span over which motion occurred. Alternatively, the motion detector can report times associated with frames having motion. In still another alternative, the motion detector can compile a series of files of predetermined length starting with frames having motion. In other alternatives, the motion detector can report some combination of frames and times or report some other indicator of motion.

From block 1972 the motion detector proceeds to block 1972 and the process 1900 is finished. In this manner, by recording quantized correlation data at the time of image capture and archive file generation, the archive file may be quickly and accurately searched for motion detection in regions of interest defined after the archive file is already built. Additionally, because the motion detector only searches the quantized correlation values, no further image processing is required during the search. This lack of image processing makes the motion detection search extremely fast. Additionally, the list of motion frames generated in block 1972 can be saved for future examination. Thus, the search does not need to be re-run at a subsequent time if the same criteria is used in a subsequent search.

As discussed above, the configuration of the host with a web server allows one or more clients to interface with the host using a web browser. Multiple clients can connect to the host and independently configure and display camera views. The multiple clients can be at the same location or can be at multiple locations. The multiple clients can typically operate independently of one another. The web interface allows the host and clients to communicate using a well established format. Additionally, the host can provide prompts to the user, and can display information to the user, in a format that is familiar to the user.

For example, the host can provide prompts for motion detection and video archiving as windows that display in the client browser. Similarly, information and commands relating to searching and viewing a clip file can be displayed in a window in the client browser.

However, as shown in FIG. 1B, a user controlling the client can transmit commands to a host control module and encoders that affect the images captured by cameras. The control over cameras can affect the images viewed by other clients. The types of camera controls that can be asserted by a user at the client is discussed below prior to discussing ways in which user control can be limited.

As noted in FIG. 1B, a user can issue pan, tilt, and zoom (PTZ) commands that change the view captured by a camera. The client devices are configured to provide a single common PTZ command set to the host that translates the common command set into the unique command set required by each of the different types of cameras.

Because PTZ commands that are physically implemented by the external cameras result in changes in the captured images, a motion detection event can occur. To prevent a motion detection event that is a result of a PTZ command, the host, through the control module, can momentarily halt the motion detection processes during a predetermined period of time following a PTZ command. The predetermined period of time can be set to allow the PTZ command to be operated by the camera prior to resuming the motion detection process.

The common PTZ command set issued by clients can result in physical or virtual PTZ control of the camera. In one embodiment, the control module in the host transforms the common PTZ commands and determines if physical or virtual PTZ control is requested. Physical PTZ control is available when the camera is physically capable of be commanded to pan, tilt, or zoom. Cameras can have motors or drives that change the physical orientation or configuration of the camera based on received commands. Virtual, or digital, PTZ commands may be issued even for cameras that do not have physical PTZ capabilities. A virtual PTZ command can result in display of a portion of the full image captured by the camera. A camera lacking physical PTZ capabilities cannot be panned or tilted if a full captured image is displayed. However, a zoom command may result in a portion of the captured image being displayed in a larger window. For example, one quarter of a captured image may be displayed in a window where normally a whole image is displayed. Thus, the image appears to be a zoomed image. However, the resolution of the image is limited by the resolution of the full image captured by the camera. Thus continued attempts to virtually zoom in on an image result in a grainy, or blocked, image. However, for many cameras, a small zoom ratio can be implemented without sacrificing much resolution.

Because the screen images produced by a computer video card may also be used as a video source, digital zoom features can be applied to screen captures. However, the digital zoom is applied to the screen capture prior to rendering the image at the resolution viewed by the user. For example, a video screen may be captured at a resolution of 1280×1020 but a viewer may only use a resolution of 320×240. A full screen capture has very low resolution when viewed at the low resolution. If digital zoom were applied to the viewed image, the resolution would remain very low. However, if digital zoom were applied to the captured image prior to rendering the image to the lower resolution, much of the captured image can be seen at the lower resolution. In this manner, a low resolution viewer may be able to digitally zoom a screen capture image without a complete loss of resolution.

Once an image is zoomed into less than a full image display, the virtual pan and tilt commands allow the image to be moved up to the limits of the full captured image. Thus, the camera behaves as if it had PTZ capabilities, but the capabilities are implemented digitally. The physical and digital PTZ capabilities do not need to operate mutually exclusively and a camera having physical PTZ capabilities can also utilize digital PTZ commands.

The host can receive the common PTZ commands and determine if a physical or digital PTZ command is to be generated. If a physical PTZ command is to be generated, the host transforms the common PTZ command to the unique PTZ command and transmits the command to the camera. If the host determines a digital PTZ command is to be generated, the command can be implemented within the host and need not be relayed to any external devices. The image that is transmitted to the requesting client is processed according to the digital PTZ command.

The user may also generate a data file storing a set of PTZ settings for a given view. The host may save the PTZ settings and apply them to the view depending on a particular event or setting. For example, a default PTZ setting for a quad view may be stored at the host and implemented as a result of motion detection within one of the captured views in the quad image. In another embodiment, a user may configure default PTZ settings for cameras in a view. The user may also configure the host to revert to the default PTZ settings in response to a motion detection event.

Thus, a user can control the PTZ settings for other cameras in response to a trigger event, such as motion detection. For example, a triggering event sensed by a first camera can initiate a control sequence that sends other cameras back to default settings or to settings defined in a command list initiated as a result of the triggering event. As previously described in connection with FIG. 2C, a motion detector module 242 can sense motion based on camera images processed by a video capture module 280. A motion response module 244 can then initiate the control sequence that includes the command list. The command list can include camera PTZ settings, dwell times, and record commands. The commands in the command list can be issued by, for example, the motion detection or event response modules of FIG. 2A or the archive module or main program module of FIG. 1C.

However, when multiple cameras each are capable of initiating command lists in response to triggering events, there needs to be a hierarchy by which the cameras respond to the various commands. In one embodiment, the hierarchy of commands is merely time based. A first in first out stack can be used to archive the commands and send them to the appropriate destination devices. Other stacks may use a first in last out hierarchy. In another embodiment, the hierarchy of commands can be time based on a predetermined command hierarchy. For example, the command hierarchy can rank all manually input user commands first, then commands generated by local event triggers, followed by commands generated by remote event triggers. Furthermore, commands at the same hierarchy level can be ranked on a time basis, on a first in first out basis or a first in last out basis.

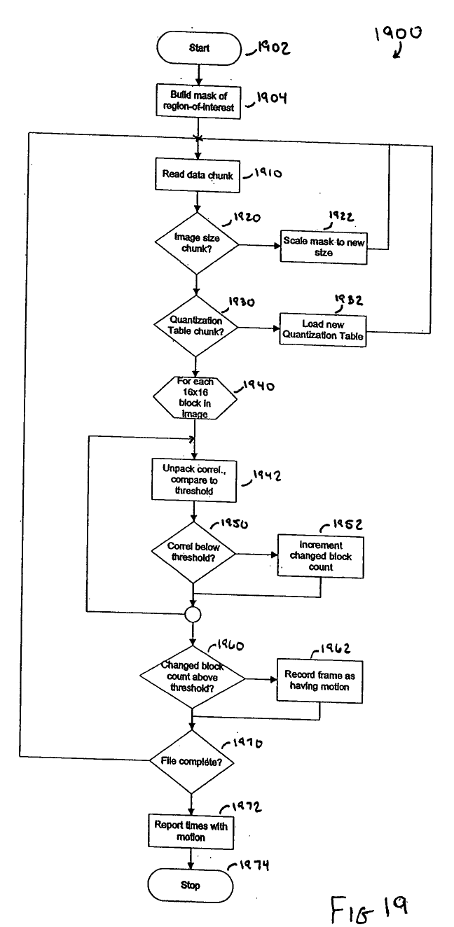

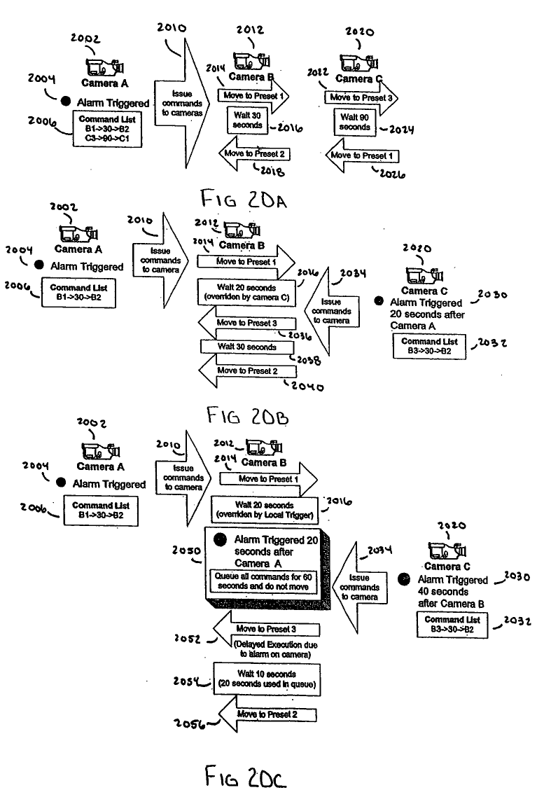

Examples of three different scenarios occurring under an embodiment of a command hierarchy are provided in FIGS. 20A-20C. Each of the command lists and event triggers shown in FIGS. 20A-20C can be, for example, initiated by a motion response module, such as module 244 of FIG. 2C. FIG. 20A is a functional diagram of the commands occurring as a result of an event trigger occurring at camera A 2002.

In FIG. 20A, camera A 2002 initiates an alarm trigger 2004, such as in response to a motion detection event. The alarm trigger 2004 at camera A 2002 initiates a command list 2006. The command list 2006 instructs camera B 2012 to move to a predetermined position B1 for 30 seconds and then move to a predetermined position B2. The command list also instructs camera C 2020 to move to predetermined position C3 for 90 seconds and then move to predetermined position C1. The predetermined positions can coincide with predetermined PTZ settings.

In response to the alarm trigger 2004, the commands in the command list 2006 are issued to the cameras in step 2010. In response to the commands, camera B 2012 moves to position B1 2014. Camera B 2012 then dwells at this position for 30 seconds 2016 and then moves to position B2 2018.

Additionally, camera C moves to position C3 2022, dwells at this position for 90 seconds 2024, and then moves to position C1 2026. As can be seen, there are no other triggering events that disrupt the commands issued by camera A 2002.

FIG. 20B shows a slightly more complicated operation in which the commands issued after a first event trigger are interrupted by commands issued by a second event trigger. Again, the sequence begins when camera A 2002 initiates a command list 2006 in response to an alarm trigger 2004. In this example, the command list requires camera B 2012 to move to position B1 for 30 seconds and then move to position B2. In response to the alarm trigger 2004 the commands are issued to the camera 2010.

In response to the command, camera B 2012 moves to position 1 2014. During the dwell period 2016, which is to last for 30 seconds, camera C 202 detects an alarm trigger 2030 which in turn initiates an independent command list 2032. The command list 2032 initiated by camera C 2020 instructs camera B 2012 to move to position B3 for 30 seconds and then move to position B2. The camera C commands 2032 are issued 2034 in response to the alarm trigger at camera C 2020.

When the camera C command is issued to camera B, there exists a command conflict that is resolved using the command hierarchy. Because both of the conflicting camera B commands originated from remote cameras, they are both at the same level of hierarchy. Camera B resolves this further conflict by executing the commands on a last in first out basis.

Thus, in response to the conflicting command from camera C, camera B moves from position B1 to position B3 2036 in response to the latest arriving command from camera C. Camera B then dwells for 30 seconds 2038 in response to the command from camera C. Finally, camera B moves to position B2 2040 in accordance with final command from both cameras A and C. Note that the final 10 seconds of the dwell time at position B1 are over ridden by the command received from camera C.

FIG. 20C details an even more complicated operation combining conflicting remote commands with conflicting locally generated commands. The sequence of events again begins with camera A 2002 detecting a triggering event 2004 and issuing a command sequence 2006 in response to the event trigger 2004. The camera A command list 2006 includes commands to move camera B to position B1 for 30 seconds and then move camera B to position B2. The commands are issued 2010 in response to the event trigger 2004.

In response to the commands, camera B 2012 moves to position B1 2016 and begins to dwell for 30 seconds 2016. However, 20 seconds into the dwell time, camera B detects a triggering event 2050, such as an alarm trigger in response to motion detection or contact closure. The local command set instructs camera B to remain stationary for 60 seconds. Because the command set is locally generated, it has priority over any remotely generated commands. Any commands of a lower hierarchy received by camera B are queued in a command queue and may be operated on later.

At a time 40 seconds after camera B detects the alarm trigger, camera C 2020 detects an alarm trigger 2030. Camera C has associated a command list 2032 to be executed upon the alarm trigger 2030. The camera C command list 2032 includes instructions for camera B to move to position B3 for 30 seconds, then move to position B2. The camera C commands are issued 2034 in response to the alarm trigger 2030.

However, as noted earlier, camera B is under the control of a local command that takes higher priority than commands issued by remote sources, such as those issued in response to events detected by camera C. Thus, camera B does not operate on remote commands, but instead queues the commands.

After the expiration of the 60 second stationary period initiated locally, camera B 2012 retrieves commands from the command queue and operates on those that have not expired. Note that the 30 second dwell time at position B1 in the command list from camera A has already expired. Camera B 2012 next operates on the command from the camera C command list 2032. Thus, camera B 2012 moves to position B3. The next command in the camera C command list instructs camera B to dwell for 30 seconds. However, 20 seconds of the 30 second dwell time have expired while camera B was under the control of local commands. Thus, only 10 seconds of the dwell time remain. Camera B only dwells at position B3 for 10 seconds 2054 instead of the originally commanded 30 seconds. However, because the conclusion of the shortened dwell time coincides with the conclusion of the dwell time as originally commanded, the subsequent commands occur at the same time as they would have if prior commands were not over ridden. Thus, after the conclusion of the dwell time, camera B 2012 moves to position B2.

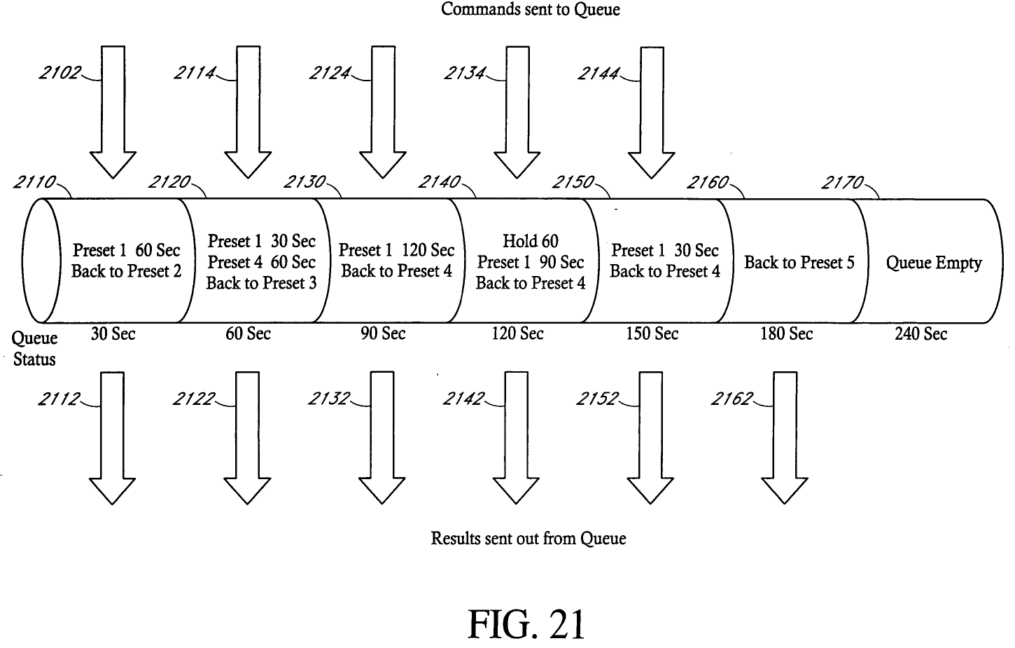

FIG. 21 is an example of a timeline of command flows in and out of a command queue for a particular camera. At time zero, the empty queue receives commands to move to preset 1 for 60 seconds then move to preset 2, 2102. The command queue 2110 then holds the commands for preset 1for 60 seconds and preset 2. The camera operates on the first queued command 2112, the command to move to preset 1.

At a time 30 seconds after the first command set is received by the command queue, a second command set 2114 is loaded into the queue. The second command set 2114 instructs the camera to move to preset 4 for 60 seconds followed by a move to preset 3. Because 30 seconds of the preset 1 dwell time have already passed, the command queue continues to contain an instruction to dwell at preset 1for 30 seconds. Additionally, the command queue includes instructions to move to preset 4, dwell at preset 4 for 60 seconds, and then move to preset 3. The command issued from the command queue 2122 is the most recent command to move to preset 4 and dwell for 60 seconds.

At a time 60 seconds after receipt of the first command set, a third command set 2124 is received by the command queue. The third command set 2124 includes instructions to move to preset 1, dwell for 120 seconds, then move to preset 4. The command queue 2130 now effectively only contains the instructions to move to preset 4 for 120 seconds and move back to preset 4 because the remaining commands in the command queue will have expired by the time the preset 1 dwell time concludes. The camera operates on the most recent instruction 2142 to move to preset 1.

At a time 90 seconds after the initial instructions, the command queue receives a fourth instruction set 2134. However, the fourth instruction set 2134 is generated locally, and thus takes priority over commands issued as a result of remote triggering events. The local command instructs the camera to hold its position for 60 seconds. Thus, the camera does not operate on any commands 2142 during this period of local control.

At a time 30 seconds later, time 120 seconds, additional commands 2144 are received by the command queue. The additional commands instruct the camera to move to preset 3 for 30 seconds followed by a move to preset 5. However, the camera is still under the control of the local hold, which doesn't expire for another 30 seconds. Thus, the move to preset 3 will never be executed, but will expire when the local hold expires.

At time 150 seconds the local hold is released and the unexpired commands from the command queue are retrieved and executed. Because 30 seconds of the 120 second dwell at preset 1 remain, the camera moves to preset 1.

After another 30 seconds have expired, the dwell time at preset 1 expires and the camera executes the only remaining command in the queue, the command to move to preset 4.

As noted above, the ability to physically change the camera PTZ settings can affect the views seen by other users. Thus, the host can implement a hierarchy of user access levels and grant user permissions based on the access level.

Access levels can be assigned to various tasks performed by the client. For example, the ability to start and stop recording can be based on an access level. Additionally, the host software can run in the background of a general purpose computer or can run in a minimally invasive manner on a general purpose computer. In one example, the host software runs in a minimized window in a windows environment. Access to the host software and the ability to view or configure the host software can be limited by access level and password.

The host, for example through control module 290, can limit viewing of video from particular cameras and the ability to add particular cameras to views based on an access level. The host can store and assign any number of access levels to users. In one embodiment, there are four different access levels; no access, viewer access, operator access, and administrator access.

No access is the lowest level of access and denies access to users a having this level of access. Viewer access allows a user to view the images or settings but does not allow the user to change any settings. Operator access allows a greater level of access. For example, an operator may be provided access to camera PTZ commands but may be denied access to archives. A highest level of access is administrator access. A user with administrator access is provided the full extent of privileges for the host capabilities.

Different users may be assigned different access levels for different host capabilities. For example a first user can be assigned viewer access for a first host capability and operator access for a second host capability. Additionally, access levels for a group of capabilities may be grouped into one category and individuals or groups can be allowed access levels corresponding to the access levels of the group. In this manner, access to critical capabilities is limited so that unauthorized users do not have the ability to disrupt the tasks performed by other system users.

For additional system security, the host can be configured to automatically perform some security tasks. For example, the host may automatically minimize its presence on the host computer display after a predetermined period of time. For example, host software running under the Windows environment can be configured to automatically minimize the operating window after a predetermined period of inactivity. Furthermore, the host software may limit the ability of a user to restore the host software to an active window. For example, the host may require entry of an authorized username and password before allowing the minimized window to be returned to active status. Similarly, the host software, such as the control process, can limit access to initial running of the software. That is, the control process can request an authorized password and username before starting the host processes.

The host may also be configured to limit client access based on an Internet address. For example, access to host control can be limited based on a range of IP addresses or a predetermined list of host names. For example, only clients having IP addresses within a predefined range may be provided access to control portions of the host.

The foregoing description details certain embodiments of the invention. It will be appreciated, however, that no matter how detailed the foregoing appears, the invention may be embodied in other specific forms without departing from its spirit or essential characteristics. The described embodiment is to be considered in all respects only as illustrative and not restrictive and the scope of the invention is, therefore, indicated by the appended claims rather than by the foregoing description. All changes which come within the meaning and range of equivalency of the claims are to be embraced within their scope.

1. A method of distributing multimedia data to remote clients, comprising:
receiving a request for data from a client;
transmitting an applet to the client;
launching the applet on the client;
receiving client-specific parameters from the applet on the client; and
sending multimedia data to the client according to the client-specific parameters.

2. The method of claim 1, wherein the applet is transmitted in a compressed form.

3. The method of claim 1, wherein the multimedia data comprises streaming video.

4. The method of claim 1, wherein the multimedia data is captured from one or more cameras and the method further comprises converting an output of the one or more cameras according to the client-specific parameters.

5. The method of claim 4, wherein a pan, a tilt, a focus, and a zoom setting of the one or more cameras is controllable by the client.

6. The method of claim 4, wherein the client selects a preset position for at least one of the cameras.

7. The method of claim 1, wherein the client is selected from the group comprising an electrical device with a display, a computer, a cell phone, and a personal digital assistant.

8. A method of archiving video images, the method comprising:
capturing a first video image;
capturing a second video image;
determining a difference between the first video image and the second video image;
encoding the difference between the first video image and the second video image; and
storing, as a frame in a video archive, an encoded difference between the first video image and the second video image.

9. The method of claim 8, further comprising periodically storing a key frame in the video archive.

10. A method of distributing multimedia data to remote clients, the method comprising:
receiving a request for a multiple image profile;
retrieving configuration data for a plurality of video sources in response to the request for the multiple image profile;
communicating a multiple image view; and
communicating a video image from the plurality of video sources for each view in the multiple image view, based on the configuration data.

11. The method of claim 10, wherein communicating the multiple image view is performed by two or more servers.

12. The method of claim 10, wherein receiving a request for the multiple image profile comprises:
receiving a request at a web server for an image view;
communicating a plurality of image views in response to the request for the image view; and
receiving a request for the multiple image view from the plurality of image views.

13. The method of claim 10, wherein in response to receiving the request for the multiple image profile at a first server, the first server communicates to the client information indicating that one or more images views should be requested from a second server.

14. A method of archiving images, the method comprising:
capturing video images;
generating correlation data corresponding to the video images;
storing compressed video images; and
storing the correlation data.

15. The method of claim 14, wherein generating correlation data comprises:
subdividing a first video frame into a plurality of blocks;
subdividing a second video frame into a plurality of blocks; and
correlating at least one of the plurality of blocks in the second video frame with a corresponding at least one of the plurality of blocks in the first video frame.

16. The method of claim 15, further comprising quantizing a correlation value associated with each of the plurality of blocks.

17. The method of claim 14, wherein generating correlation data comprises:
receiving a first video frame;
receiving a subsequent video frame; and
correlating a block of the first video frame to a block of the subsequent video frame to generate a correlation value.

18. The method of claim 15, wherein the correlation data comprises a plurality of correlation values each indicative of a change in one of a plurality of corresponding blocks of the first video frame and the subsequent video frame.

19. The method of claim 18, wherein each of the plurality of correlations values is between −1 and 1.

20. A method of monitoring motion in video data comprising a plurality of video frames, the method comprising:
comparing a plurality of correlation values to a predetermined threshold, wherein each of said plurality of correlation values is associated with a block of a particular video frame;
determining a number indicative of how many correlation values associated with the particular video frame that exceed the predetermined threshold; and
indicating motion if the determined number of correlation values is greater than a second predetermined threshold.

21. The method of claim 20, wherein the video data is streaming data acquired from a video recording device.

22. The method of claim 21, wherein in response to indicating motion, initiating a second video recording device to adjust at least one of a pan, tilt, focus, and zoom settings for a predetermined period of time.

23. The method of claim 20, wherein the video data is stored on one or more servers.

24. The method of claim 20, wherein the predetermined threshold is determined by a user.

25. The method of claim 20, wherein each video frame is divided into a plurality of blocks and the user selects less than all of the plurality of blocks for use in the step of comparing.

26. A method of archiving data in a multimedia capture system, the method comprising:
configuring a first storage node for storing multimedia data;
configuring a storage threshold associated with the first storage node;
configuring a second storage node for storing multimedia data;
configuring a storage threshold associated with the second storage node;
transferring multimedia data from a capture device to the first storage node while a total amount of multimedia data transferred to the first storage node remains less than the storage threshold associated with the first storage node; and
transferring multimedia data from a capture device to the second storage node after the total amount of multimedia data transferred to the first storage node is not less than the storage threshold associated with the first storage node and while a total amount of multimedia data transferred to the second storage node data remains less than the storage threshold associated with the second storage node.

27. The method of claim 26, wherein the first storage threshold indicates an amount of data.

28. The method of claim 26, wherein the first storage threshold indicates a percentage of a total storage capacity of the first storage node.

29. The method of claim 26, further comprising specifying a location on the first storage node for storage of the multimedia data.

30. The method of claim 26, wherein at least one of the first and second storage nodes are in communication with the multimedia capture system via a network.

31. The method of claim 26, further comprising notifying a user when the storage threshold associated with the second storage node has been met.

32. The method of claim 26, wherein transferring multimedia data from the capture device to the first storage device begins after the capture device detects motion in the multimedia data.

33. A method of monitoring activity, the method comprising:
comparing a sensor output at a first location to a predetermined threshold;
initiating, in response to the step of comparing, a multimedia event; and
storing multimedia data at a second location related to the multimedia event.

34. The method of claim 33, wherein the multimedia event is selected from the group of: recording video, recording audio, playing video, playing audio, and activating an alarm.

35. A method of prioritizing requests for adjustment of video recording device attributes received from more than one source, the method comprising:
setting as a first priority any requests to change the video recording device attributes that are received from a user;
setting as a second priority any requests to change the video recording device attributes that are stored as default attributes;
setting as a third priority any requests to change the video recording device attributes that are automatically generated due to a triggering event at another video recording device; and
adjusting the video recording device attributes according to the top priority request.

36. The method of claim 35, wherein the video recording device attributes include at least a pan, tilt, and zoom setting.

37. The method of claim 35, wherein the video recording device is a security camera.

38. The method of claim 35, wherein the triggering event is a detection of motion by the another video recording device.
